(19) United States
(12) Patent Application Publication
(10) Pub. No.: US 2026/0185544 A1
(43) Pub. Date: Jul. 2, 2026

(54) HYDRAULICALLY POWERED POWER SYSTEM FOR CONTROLLING INPUT ENGINE POWER OR INPUT MOTOR POWER

(71) Applicant: Illinois Tool Works Inc., Glenview, IL (US)

(72) Inventor: Nathan Joe Jochman, Neenah, WI (US)

(21) Appl. No.: 19/434,517

(22) Filed: Dec. 29, 2025

Related U.S. Application Data
(60) Provisional application No. 63/740,737, filed on Dec. 31, 2024.

(51) Int. Cl. F15B 11/02; F15B 15/18; F15B 19/00

(52) U.S. Cl. CPC F15B 11/02; F15B 15/18; F15B 19/00

(57) ABSTRACT

A hydraulically powered power system comprises: a hydraulic pump configured to receive input power from an engine and to convert the input power to an input hydraulic flow; hydraulic output equipment configured to receive the input hydraulic flow to generate a first output; and control circuitry configured to: calculate an engine speed adjustment based on a first target operating characteristic of the hydraulic output equipment and a measured engine speed of the engine, and upon calculating the engine speed adjustment, output a control signal to control the engine to modify an engine speed of the engine based on the engine speed adjustment to modify a flow characteristic of the input hydraulic flow.

### RELATED APPLICATIONS

The present application claims the benefit of U.S. Provisional Patent Application Ser. No. 63/740,737, filed Dec. 31, 2024, entitled “HYDRAULICALLY POWERED POWER SYSTEM FOR CONTROLLING INPUT ENGINE POWER OR INPUT MOTOR POWER.” The entirety of U.S. Provisional Patent Application Ser. No. 63/740,737 is expressly incorporated herein by reference.

### FIELD OF THE DISCLOSURE

This disclosure relates generally to generators powered by engines and/or motors and, more particularly, to hydraulically powered power systems for controlling input engine power.

### BACKGROUND

Hydraulically powered power systems use hydraulic fluid to generate power. For example, a hydraulically powered power system may include a hydraulic pump which pumps hydraulic fluid through a hydraulic circuit comprising a hydraulically powered device. The hydraulic pump may power a hydraulically driven motor (e.g., a “hydraulic motor”), thereby actuating the hydraulic motor to generate and output mechanical power to a mechanically powered device.

### SUMMARY

Hydraulically powered power systems for controlling input engine power and/or input motor power are disclosed, substantially as illustrated by and described in connection with at least one of the figures, as set forth more completely in the claims.

### BRIEF DESCRIPTION OF THE DRAWINGS

FIG. 1 illustrates a block diagram of an example of a hydraulically powered power system, in accordance with aspects of this disclosure;

FIG. 2 illustrates a block diagram of an example of a hydraulic circuit, in accordance with aspects of this disclosure;

FIG. 3 illustrates a block diagram of an example of control circuitry of a hydraulically powered power system, in accordance with aspects of this disclosure; and

FIG. 4 illustrates a flowchart representative of an exemplary process for controlling a hydraulically powered power system and/or one or more components thereof, in accordance with aspects of this disclosure.

The figures are not necessarily to scale. Where appropriate, similar or identical reference numbers are used to refer to similar or identical components.

### DETAILED DESCRIPTION

Some disclosed example hydraulically powered power systems and methods involve adjusting an engine speed of an engine based on a measured operating characteristic of a generator and a target operating characteristic of a generator. Some disclosed example hydraulically powered power systems and methods involve adjusting a motor speed of a motor based on a measured operating characteristic of a generator and a target operating characteristic of a generator.

A disclosed example hydraulically powered power system includes a hydraulic pump, which is used to generate an input hydraulic flow of hydraulic fluid, which is pumped through a hydraulic circuit. The hydraulic pump generates the input hydraulic flow by receiving input power (e.g., a rotational power) from a power source (e.g., an engine, an electric motor, and/or one or more other type(s) of motors). Accordingly, in some disclosed examples, the hydraulic pump is drivingly coupled to the power source (e.g., via one or more drive shafts and/or linkages).

The hydraulic circuit may comprise and/or be hydraulically coupled to hydraulic output equipment (e.g., via one or more hydraulic couplers), such that the hydraulic pump provides the input hydraulic flow to the hydraulic output equipment. Accordingly, the hydraulic pump may hydraulically power hydraulic output equipment by using the input power to pump the input hydraulic flow through the hydraulic circuit, and a magnitude of an output generated by the hydraulic output equipment may depend on a flow characteristic (e.g., a flow rate, flow velocity, pressure, temperature, heat output, oil weight, etc.) of the input hydraulic flow pumped by the hydraulic pump and/or of hydraulic fluid within the hydraulic circuit. One or more flow characteristics may be partially or wholly a function of one or more pump operating characteristics of a hydraulic pump. A pump operating characteristic may include a pump displacement (e.g., an amount of hydraulic fluid displaced per stroke, revolution, and/or one or more other intervals of a movement of a piston and/or one or more other components of a hydraulic pump, an amount of hydraulic fluid displaced by a hydraulic pump during a predefined amount of time, etc.), a pump speed (e.g., a linear and/or rotational speed of a piston or other component of a hydraulic pump), a pump torque (e.g., a rotational force generated by one or more components of a hydraulic pump), a piston force (e.g., a linear force generated by a piston or other component of a hydraulic pump), and/or one or more other operating characteristics of a hydraulic pump.

In some disclosed examples, the hydraulic output equipment includes a hydraulic motor configured to convert the input hydraulic flow to motor power (e.g., rotational power). In some such examples, the hydraulic motor is mechanically coupled to mechanical output equipment (e.g., via one or more drive shafts, one or more linkages, and/or one or more mechanical couplers), such that the hydraulic motor provides the motor power to the mechanical output equipment. Accordingly, the hydraulic pump may hydraulically power a hydraulic motor such that the hydraulic motor mechanically powers mechanical output equipment by using the input hydraulic flow to generate the motor power, and a magnitude of an output generated by the mechanical output equipment may depend on a magnitude of motor power (e.g., as measured in rotations per minute (“RPM”), foot-pounds, etc.) generated by the hydraulic motor. Because the magnitude of motor power generated by the hydraulic motor may depend wholly or partially on one or more flow characteristics (e.g., a flow rate, flow velocity, pressure, temperature, heat output, oil weight, etc.) of the input hydraulic flow generated by the hydraulic pump and received by the hydraulic motor, the magnitude of the output generated by the mechanical output equipment may, thereby, also wholly or partially depend on the flow characteristic of the input hydraulic flow generated by the hydraulic pump and received by the hydraulic motor.

In some disclosed examples, the power source may be an engine (e.g., an engine of a vehicle, a combustion engine, etc.) drivingly coupled to the hydraulic pump (e.g., via one or more drive shafts), and the hydraulic pump receives input power (e.g., a rotational power generated via rotating one or more drive shafts) from the engine and converts the input power to the input hydraulic flow. Accordingly, in some disclosed example hydraulically powered power systems, input power is generated by an engine, a hydraulic pump receives the input power and converts the input power to an input hydraulic flow, and hydraulic output equipment receives the input hydraulic flow to generate an output. In some such disclosed example hydraulically powered power systems, the hydraulic output equipment includes a hydraulic motor, the hydraulic motor receives the input hydraulic flow and converts the input hydraulic flow to a motor power, and mechanical output equipment receives the motor power to generate an output.

In some disclosed examples, the power source may be an electric motor (e.g., an electric motor of a vehicle, etc.) drivingly coupled to the hydraulic pump (e.g., via one or more drive shafts), and the hydraulic pump receives input power (e.g., a rotational power generated via rotating one or more drive shafts) from the electric motor and converts the input power to the input hydraulic flow. Accordingly, in some disclosed example hydraulically powered power systems, input power is generated by an electric motor, a hydraulic pump receives the input power and converts the input power to an input hydraulic flow, and hydraulic output equipment receives the input hydraulic flow to generate an output. In some such disclosed example hydraulically powered power systems, input power is generated by an electric motor, a hydraulic pump receives the input power and converts the input power to an input hydraulic flow, a hydraulic motor receives the input hydraulic flow and converts the input hydraulic flow to a motor power, and mechanical output equipment receives the motor power to generate an output.

Modifying an output of hydraulic output equipment may be done by, e.g., modifying functionality of the hydraulic output equipment to throttle the output. Similarly, modifying an output of mechanical output equipment may be done by, e.g., modifying functionality of the mechanical output equipment to throttle the output. However, each of these mechanisms for modifying outputs of hydraulic output equipment and/or mechanical output equipment may be inefficient. For example, each of these mechanisms may involve the generation of input power by, e.g., an engine and/or an electric motor in excess of an amount actually necessary for providing a desired magnitude of the output.

Accordingly, some disclosed examples calculate an engine speed adjustment based on a target operating characteristic of output equipment (e.g., hydraulic output equipment and/or mechanical output equipment) and control an engine to modify an engine speed of the engine based on the engine speed adjustment to modify a pump characteristic of a hydraulic pump that receives an input power from the engine and/or a flow characteristic of an input hydraulic flow generated by the hydraulic pump. Similarly, some disclosed examples calculate a motor speed adjustment based on a target operating characteristic of output equipment (e.g., hydraulic output equipment and/or mechanical output equipment) and control an electric motor to modify a motor speed of the electric motor based on the motor speed adjustment to modify a flow characteristic of an input hydraulic flow generated by a hydraulic pump that receives an input power from the electric motor.

Disclosed example hydraulically powered power systems comprise: a hydraulic pump configured to receive input power from an engine and to convert the input power to an input hydraulic flow; hydraulic output equipment configured to receive the input hydraulic flow to generate a first output; and control circuitry configured to: calculate an engine speed adjustment based on a first target operating characteristic of the hydraulic output equipment and a measured engine speed of the engine, and upon calculating the engine speed adjustment, output a control signal to control the engine to modify an engine speed of the engine based on the engine speed adjustment to modify a flow characteristic of the input hydraulic flow.

In some disclosed example hydraulically powered power systems, the hydraulic output equipment comprises a first hydraulic auxiliary device configured to generate a first input signal comprising a first measured operating characteristic of the first hydraulic auxiliary device; and the control circuitry is further configured to monitor the first input signal to determine a first operating characteristic difference based on the first target operating characteristic and the first measured operating characteristic, wherein the calculating of the engine speed adjustment is further based on the first operating characteristic difference. In some such disclosed example hydraulically powered power systems, the hydraulic output equipment further comprises a second hydraulic auxiliary device configured to generate a second input signal comprising a second measured operating characteristic of the second hydraulic auxiliary device to the control circuitry; and the control circuitry is further configured to monitor the second input signal to determine a second operating characteristic difference based on a second target operating characteristic and the second measured operating characteristic, wherein the calculating of the engine speed adjustment is further based on the second operating characteristic difference.

In some disclosed example hydraulically powered power systems, the hydraulic output equipment comprises a first hydraulic auxiliary device configured to generate a first input signal comprising a first measured operating characteristic of the first hydraulic auxiliary device; the control circuitry is further configured to monitor the first input signal to determine a first operating characteristic difference based on the first target operating characteristic and the first measured operating characteristic, wherein the calculating of the engine speed adjustment is further based on the first operating characteristic difference; the first target operating characteristic comprises a target received hydraulic flow characteristic of the first hydraulic auxiliary device; the first measured operating characteristic comprises a measured received hydraulic flow characteristic of the first hydraulic auxiliary device; the first hydraulic auxiliary device comprises a user interface configured to generate a user interface signal; and the control circuitry is further configured to determine the target received hydraulic flow characteristic based on the user interface signal.

In some disclosed example hydraulically powered power systems, the hydraulically powered power system further comprises one or more hydraulic couplers configured to receive the input hydraulic flow and hydraulically couple to one or more hydraulic auxiliary devices configured to generate a second output by receiving the input hydraulic flow, wherein the calculating of the engine speed adjustment is further based on a second target operating characteristic of the one or more hydraulic auxiliary devices.

In some disclosed example hydraulically powered power systems, the hydraulic output equipment comprises a hydraulic motor configured to convert the input hydraulic flow to motor power.

In some such disclosed example hydraulically powered power systems, the hydraulically powered power system further comprises mechanical output equipment configured to receive the motor power to generate a second output, wherein the calculating of the engine speed adjustment is further based on a second target operating characteristic of the mechanical output equipment.

In some disclosed example hydraulically powered power systems, the hydraulic output equipment comprises a hydraulic motor configured to convert the input hydraulic flow to motor power; and one or more mechanical couplers configured to receive the motor power and mechanically couple to a mechanical auxiliary device configured to generate a second output by receiving the motor power, wherein the calculating of the engine speed adjustment is further based on a second target operating characteristic of the mechanical auxiliary device.

In some disclosed example hydraulically powered power systems, the control circuitry is further configured to, upon determining that the first target operating characteristic is a standby mode indication, control the engine to operate in a standby mode.

In some disclosed example hydraulically powered power systems, the control circuitry is further configured to, upon determining that the first target operating characteristic comprises a synchronized speed mode indication, control the engine to operate in a synchronized speed mode.

In some disclosed example hydraulically powered power systems, the control circuitry is further configured to, upon determining that the first target operating characteristic is a variable speed mode indication, control the engine to operate in a variable speed mode.

In some disclosed example hydraulically powered power systems, the control circuitry is further configured to, upon determining that the first target operating characteristic is a fixed speed mode indication, control the engine to operate in a fixed speed mode.

In some disclosed example hydraulically powered power systems, the first target operating characteristic comprises at least one of a predetermined target value or a predetermined target value range.

Disclosed example hydraulically powered power systems comprise: a hydraulic pump configured to receive input power from an engine and to convert the input power to an input hydraulic flow; one or more hydraulic couplers configured to receive the input hydraulic flow and hydraulically couple to one or more hydraulic auxiliary devices configured to generate a first output by receiving the input hydraulic flow; and control circuitry configured to: calculate an engine speed adjustment based on a first target operating characteristic of the one or more hydraulic auxiliary devices and a measured engine speed of the engine, and upon calculating the engine speed adjustment, output a control signal to control the engine to modify an engine speed of the engine based on the engine speed adjustment to modify a flow characteristic of the input hydraulic flow.

In some disclosed example hydraulically powered power systems, the hydraulically powered power system further comprises a hydraulic motor configured to convert the input hydraulic flow to motor power. In some such disclosed example hydraulically powered power systems, the hydraulically powered power system further comprises mechanical output equipment configured to receive the motor power to generate a second output, wherein the calculating of the engine speed adjustment is further based on a second target operating characteristic of the mechanical output equipment.

In some disclosed example hydraulically powered power systems, the hydraulically powered power system further comprises: a hydraulic motor configured to convert the input hydraulic flow to motor power; and one or more mechanical couplers configured to receive the motor power and mechanically couple to a mechanical auxiliary device configured to generate a second output by receiving the motor power, wherein the calculating of the engine speed adjustment is further based on a second target operating characteristic of the mechanical auxiliary device.

Disclosed example hydraulically powered power system comprises: a hydraulic pump configured to receive input power from an engine and to convert the input power to an input hydraulic flow; a hydraulic motor configured to convert the input hydraulic flow to motor power; mechanical output equipment configured to receive the motor power to generate an output; and control circuitry configured to: calculate an engine speed adjustment based on a target operating characteristic of the mechanical output equipment and a measured engine speed of the engine, and upon calculating the engine speed adjustment, output a control signal to control the engine to modify an engine speed of the engine based on the engine speed adjustment to modify a flow characteristic of the input hydraulic flow.

In some disclosed example hydraulically powered power systems, the mechanical output equipment comprises a mechanical auxiliary device configured to generate an input signal comprising a measured operating characteristic of the mechanical auxiliary device; and the control circuitry is further configured to monitor the input signal to determine an operating characteristic difference based on the target operating characteristic and the measured operating characteristic, wherein the calculating of the engine speed adjustment is further based on the operating characteristic difference.

In some such disclosed example hydraulically powered power systems, the target operating characteristic comprises a target received motor power of the mechanical auxiliary device; the measured operating characteristic comprises a measured received motor power of the mechanical auxiliary device; the mechanical auxiliary device comprises a user interface configured to generate a user interface signal; and the control circuitry is further configured to determine the target received motor power based on the user interface signal.

As used herein, the term “electric motor” includes any device capable of converting electrical power (e.g., alternating current (“AC”) power and/or direct current (“DC”) power) into linear or rotary motion.

As used herein, the term “hydraulic power system” includes a system having a motor, a fluid reservoir, and a pump. The hydraulic power system applies hydraulic pressure to one or more devices and/or systems by generating a hydraulic flow of a hydraulic fluid through a hydraulic circuit to drive, e.g., motors, shafts, cylinders, and/or other parts of the one or more devices and/or systems.

As used herein, the term “hydraulic pump” describes a device to convert mechanical power into hydraulic energy, thereby serving as a source for mechanical power output, such as to a hydraulic motor. For example, a hydraulic pump may generate a hydraulic flow of a hydraulic fluid through a hydraulic circuit.

A hydraulic flow may be a function of, defined by, and/or exhibit one or more flow characteristics (e.g., a flow rate, flow velocity, pressure, temperature, heat output, oil weight, etc.) of a hydraulic fluid. The term “flow rate,” as used herein with respect to hydraulic flow, refers to the volume of hydraulic fluid transferred through a region per unit of time. For example, a “flow rate” of a hydraulic flow may be measured in cubic meters per second (“cms”), cubic feet per second (“cfs”), gallons per minute (“gpm”), etc. The term “flow velocity,” as used herein with respect to hydraulic flow, refers to the distance traveled by a hydraulic fluid per unit of time. For example, a “flow velocity” of a hydraulic flow may be measured in meters per second (“mps”), feet per second (“fps”), miles per hour (“mph”), etc.

As used herein, the term “hydraulic motor” includes any device capable of converting fluid flow into linear or rotary motion. Example hydraulic motors operate by converting fluid flow from a hydraulic pump into a rotary motion as a motor output shaft is driven by the pressurized fluid acting on one or more components of the hydraulic motor (e.g., gears, pistons, etc.).

The term “power” is used throughout this specification, for convenience, to describe hydraulic power, mechanical power, electrical power, and/or one or more other types of power. However, the term “power,” as used herein, also includes related measures, aspects, and/or qualities of hydraulic power, mechanical power, electrical power, and/or one or more types of power. Controlling “hydraulic power” may involve controlling a pump operating characteristic of a hydraulic pump (e.g., a pump displacement, pump speed, pump torque, piston force, etc.) and/or a flow characteristic of a hydraulic flow and/or a hydraulic fluid (e.g., a flow rate, flow velocity, pressure, temperature, heat output, oil weight, etc.). As another example, controlling “mechanical power” may involve controlling a rotational speed, a rotational acceleration, a rotational force, a linear speed, a linear acceleration, and/or a linear force. As yet another example, controlling “electrical power” may involve controlling voltage, current, energy, resistance, conductance, and/or enthalpy. Accordingly, controlling based on “power” may involve controlling based on any, some, or all of controlling a pump operating characteristic (e.g., a pump displacement, pump speed, pump torque, piston force, etc.), a flow characteristic (e.g., a flow rate, flow velocity, pressure, temperature, heat output, oil weight, etc.), rotational speed, rotational acceleration, rotational force, linear speed, linear acceleration, linear force, voltage, current, energy, resistance, conductance, and/or enthalpy.

As used herein, the term “welding-type power” refers to power suitable for welding, plasma cutting, induction heating, air carbon arc cutting (“CAC-A”) and/or hot wire welding/preheating (including laser welding and laser cladding). As used herein, the term “welding-type power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the term “output equipment” refers to one or more devices that receive power (e.g., input power, input hydraulic flow, motor power, an electrical output, welding-type power, etc.) from one or more systems (e.g., a hydraulically powered power system, a hydraulic circuit, etc.), devices (e.g., a power source, a hydraulic pump, a hydraulic motor, a generator, power conversion circuitry), and/or components to generate an output (e.g., one or more type(s) of power and/or functions produced using the received power).

As used herein, the term “processor” refers to processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general-purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory storage device.

As utilized herein the terms “circuits,” “circuitry,” “controller,” and “control circuitry” refer to physical electronic components (i.e., hardware) and any software and/or firmware (“code”) which may configure the hardware, be executed by the hardware, and/or otherwise be associated with the hardware. As used herein, for example, a “circuit” may comprise any analog and/or digital components, power and/or control elements (such as a microprocessor, digital signal processor (DSP), software, and the like), discrete and/or integrated components, associated software, hardware, and/or firmware, and/or portions and/or combinations thereof. As used herein, for example, a particular processor and memory storage device may comprise a first “circuit” when executing a first set of one or more lines of code and may comprise a second “circuit” when executing a second set of one or more lines of code. As utilized herein, circuitry is “operable” to, “configurable to,” and/or “configured to” perform a function whenever the circuitry comprises the necessary hardware and code (if any is necessary) to perform the function, regardless of whether performance of the function is disabled or not enabled (for example, by an operator-configurable setting, factory trim, etc.).

As used herein, the term “communication circuitry” refers to physical electronic components (i.e., hardware) and, in some examples, any software and/or firmware (i.e., code) which may configure the hardware, be executed by the hardware, and/or otherwise enable the hardware to communicate with one or more other devices (e.g., with communication circuitry of such one or more other devices). Communication circuitry may include hardware capable of wired and/or wireless communication with one or more other devices. Hardware capable of wired communication may include one or more cables or other optical communication mechanisms, one or more computer buses, and/or one or more additional wired mechanisms for communicating with one or more communications networks and/or one or more devices. Hardware capable of wireless communications may include one or more transceivers, one or more antennas, one or more modems, one or more local area network (“LAN”) ports, one or more wireless fidelity (“Wi-Fi”) cards, one or more WiMax cards, mobile communications hardware, near-field communication hardware, satellite communication hardware, hardware configured to communicate in accordance with one or more wireless communication protocols (e.g., IrDA, Bluetooth, Wireless USB, Z-Wave, ZigBee, radio frequency identification (“RFID”), one or more other near field communications (“NFC”) protocols, and/or one or more other protocols for close-proximity and/or wireless communication), and/or other hardware for wirelessly communicating with one or more communications networks and/or one or more devices. Communication circuitry may include one or more network interfaces, one or more input-output (“I/O”) interfaces, and/or one or more other interfaces for communicating data (e.g., directly, via one or more communications paths, etc.) to and/or from one or more communications networks. An example network interface may include hardware, firmware, and/or software to communicatively couple communication circuitry to one or more communications networks. A network interface may include and/or be coupled to one or more communication paths. A communication path includes hardware which provides signal interconnectivity between one or more components (e.g., control circuitry and a transceiver). A network interface may include any hardware for transmitting and/or receiving communications (e.g., IEEE 802.X-compliant wireless and/or wired communications hardware). An example I/O interface includes hardware, firmware, and/or software to connect one or more I/O devices to control circuitry (communicatively coupled to, e.g., communication circuitry comprising the I/O interface) for providing input to the control circuitry and/or providing output from the control circuitry. For example, the I/O interface may include a graphics processing unit for interfacing with a display device, a universal serial bus port for interfacing with one or more USB-compliant devices, a FireWire, a field bus, and/or any other type of interface. Example I/O device(s) may include a keyboard, a keypad, a mouse, a trackball, a pointing device, a microphone, an audio speaker, a display device, an optical media drive, a multi-touch touch screen, a gesture recognition interface, a magnetic media drive, and/or any other type of input and/or output device. Control circuitry communicatively coupled to an I/O interface may access a non-transitory machine-readable medium via the I/O interface and/or one or more I/O device(s). Examples of a machine-readable medium include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine-readable media.

A “communications network,” as the term is used herein, may include one or more of the Internet, one or more personal area networks (“PAN(s)”), one or more LANs, one or more wide area networks (“WAN(s)”), one or more cellular networks, one or more satellite networks, one or more global positioning systems, one or more other such networks, and/or any combination thereof. A LAN may include one or more wired technologies (e.g., Ethernet, USB, etc.) and/or one or more wireless technologies (e.g., Wi-Fi). A PAN may include one or more wired technologies (e.g., USB, FireWire, and/or one or more other computer buses) and/or one or more wireless technologies (e.g., Bluetooth, Wireless USB, IrDA, Z-Wave, ZigBee, RFID, one or more other NFC protocols, and/or one or more other protocols for close-proximity and/or wireless communication). A cellular network may include technologies such as LTE, WiMAX, UMTS, CDMA, GSM, 3G, 4G, 5G, 6G, and/or one or more other technologies.

As used, herein, the terms “memory,” “memory storage device,” and/or “memory device” refer to computer hardware or circuitry to store information for use by a processor and/or other digital device. The memory, memory storage device, and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory, memory storage device, and/or memory device can be configured to store code, instructions, applications, software, firmware, and/or data, and may be external, internal, or both with respect to a processor.

As used herein, the terms “torch,” “welding torch,” “welding tool,” and “welding-type tool” can include a hand-held or robotic welding torch, gun, or other device used to create the welding arc.

As used herein, the term “electrode” includes any consumable or non-consumable material which may be controllably provided to a welding torch by welding equipment and which may conduct a weld current (e.g., welding wire).

As used herein, the term “welding mode” refers to the type and/or modality of process and/or output used by a welding system, such as constant current (“CC”) welding, constant voltage (“CV”) welding, pulse welding, metal inert gas (“MIG”) welding or gas metal arc welding (“GMAW”), tungsten inert gas (“TIG”) welding or gas tungsten arc welding (“GTAW”), flux cored arc welding (“FCAW”), shielded metal arc welding (“SMAW”, or “stick welding”), plasma cutting, spray welding, short circuit transfer welding, etc.

As used herein, the term “welding operation” refers to a process of welding one or more materials, components, etc. using one or more welding modes.

As used herein, the terms “welding system” and “welding-type system” refer to systems capable of generating and/or conditioning welding power and/or of conducting a welding operation (e.g., by generating, conditioning, and/or receiving welding power). A welding system or welding-type system may operate and/or be capable of operating in only one welding mode and/or in any plurality of welding modes.

As used herein, the term “boost converter” refers to a converter used in a circuit that boosts a voltage. For example, a boost converter can be a type of step-up converter, such as a DC-to-DC power converter that steps up voltage while stepping down current from its input (e.g., from an energy storage device) to its output (e.g., a load and/or attached power bus). It is a type of switched mode power supply.

As used herein, the term “buck converter” (e.g., a step-down converter) refers to a power converter which steps down voltage (e.g., while stepping up current) from its input to its output.

Features described herein make reference to the accompanying drawings in which exemplary embodiments of the disclosure are shown. Whenever appropriate, the same reference numerals are used throughout the drawings to refer to the same or like parts. However, it should be understood that the systems of this disclosure can be embodied in many different forms and should not be construed as limited to the embodiments set forth herein.

It is to be understood that, as used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage, or mode of operation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.” and “for example” set off lists of one or more non-limiting examples, instances, or illustrations. While various features, elements or steps of particular embodiments can be disclosed using the transitional phrase “comprising,” it is to be understood that alternative embodiments, including those that can be described using the transitional phrases “consisting of” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

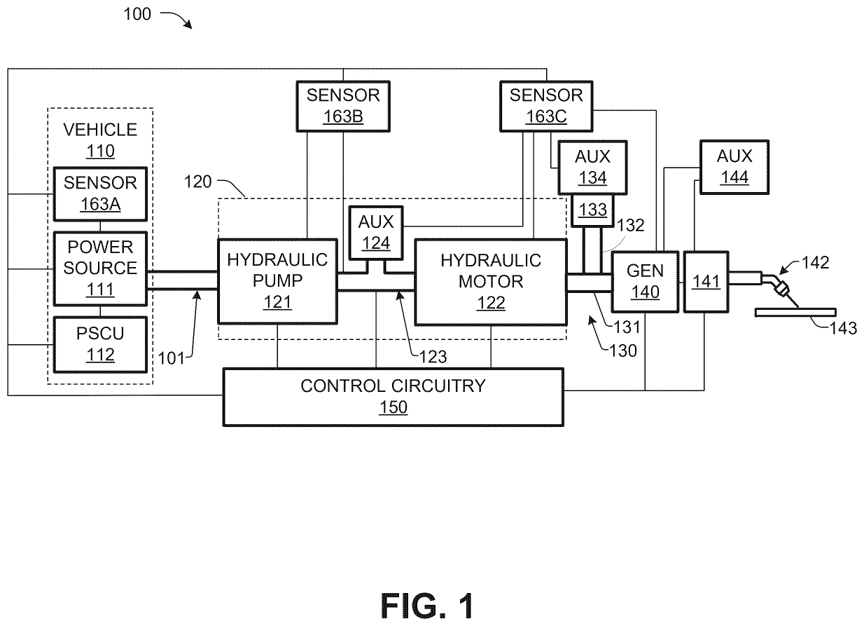

FIG. 1 is a block diagram of an example of a system 100. The system 100 is a hydraulically powered power system, and, in the example depicted in FIG. 1, includes a power source 111, and a hydraulic circuit 120. In the example of FIG. 1, the system 100 further includes a control circuitry 150, which may be used to control one or more components of the system 100 (e.g., by outputting a control signal). The power source 111 generates an input power for the hydraulic circuit 120, and, thereby, provides some or all of the power used by the hydraulic circuit 120. In some examples, the system 100 includes a plurality of power sources comprising the power source 111.

In some examples, the power source 111 is and/or includes one or more engines (e.g., one or more vehicular engines, one or more non-vehicular engines, and/or one or more other engines) and/or one or more motors (e.g., one or more electric motors, one or more vehicular motors, and/or one or more other motors). In the example of FIG. 1, the power source 111 is and/or includes an engine and/or motor of a vehicle 110 (e.g., a truck, a car, etc.). In some examples, the system 100 may include and/or receive power from any plurality of vehicles including the vehicle 110. In some examples, the system 100 does not include the vehicle 110 (e.g., the power source 111 is a free-standing power source and/or a power source of another system and/or device).

The system 100 includes a hydraulic pump 121 drivingly coupled to the power source 111. Accordingly, the hydraulic pump 121 receives the input power from the power source 111 and converts the input power to an input hydraulic flow of a hydraulic fluid (e.g., hydraulic oil) within the hydraulic circuit 120. The hydraulic pump 121 may receive the hydraulic fluid from or via, e.g., a fluid reservoir of the hydraulic circuit 120, a fluid return line of the hydraulic circuit 120, etc. One or more input linkages 101 may drivingly couple the hydraulic pump 121 to the power source 111 by, e.g., being directly coupled to the power source 111, coupling to a drive shaft rotated by the power source 111, etc. The one or more input linkages 101 may include one or more drive shafts, one or more clutches, one or more transmissions, one or more belts, one or more gear boxes, one or more keyway couplers, one or more splines, one or more flexible couplers, one or more spider couplers, one or more flex plates, one or more flange mounts, one or more other drive shaft mounts (to, e.g., mount to a drive shaft rotated by the power source 111), one or more drive shaft couplers, and/or one or more other mechanical linkages.

The example hydraulic pump 121 pumps hydraulic fluid through the hydraulic circuit 120 to provide an input hydraulic flow to hydraulic output equipment to enable the hydraulic output equipment produce an output (e.g., a motor power, compressed air, welding power, lifting power, stabilizing power, rotational power, one or more other types of mechanical and/or electrical power, etc.). As used herein, the term “hydraulic output equipment” refers to one or more devices, one or more systems, and/or one or more components that receive hydraulic power (e.g., input hydraulic flow of a hydraulic fluid) from one or more devices (e.g., one or more hydraulic pumps), systems (e.g., a hydraulic circuit), and/or components. For example, hydraulic output equipment may include one or more of any, some, or all of a hydraulic motor, an air compressor, a welder, an outrigger, a truck stabilizer, a crane, a hydraulic lift, a grinder, and/or one or more other hydraulically powered tools and/or devices.

The system 100 may include one or more hydraulic motors and/or one or more other hydraulic auxiliary devices. In the example of FIG. 1, the system 100 includes a hydraulic motor 122 and one or more hydraulic auxiliary devices 124. The hydraulic pump 121 provides the input hydraulic flow to both the hydraulic motor 122 and the one or more hydraulic auxiliary devices 124 via one or more hydraulic linkages 123. Accordingly, the one or more hydraulic linkages 123 hydraulically couple the hydraulic pump 121 to the hydraulic motor 122 and/or to the one or more hydraulic auxiliary devices 124 to provide the input hydraulic flow and/or another hydraulic flow to the hydraulic motor 122 and/or at least one of the one or more hydraulic auxiliary devices 124 to provide the hydraulic motor 122 and/or at least one of the one or more hydraulic auxiliary devices 124 with hydraulic power. In some examples, the one or more hydraulic auxiliary devices 124 may include one or more of any, some, or all of a hydraulic motor (e.g., one or more hydraulic motors in addition to the hydraulic motor 122), an air compressor, a welder, an outrigger, a truck stabilizer, a crane, a hydraulic lift, a grinder, and/or one or more other hydraulically powered tools and/or devices.

In some examples, the one or more hydraulic linkages 123 hydraulically couple the hydraulic motor 122 and/or one or more of the one or more hydraulic auxiliary devices 124 in series. For example, the hydraulic motor 122 and/or one or more first hydraulic auxiliary devices of the one or more hydraulic auxiliary devices 124 may receive the input hydraulic flow downstream of the hydraulic motor 122 and/or one or more second hydraulic auxiliary devices of the one or more hydraulic auxiliary devices 124. In some additional and/or alternative examples, the one or more hydraulic linkages 123 hydraulically couple the hydraulic motor 122 and/or one or more of the one or more hydraulic auxiliary devices 124 in parallel. For example, the hydraulic motor 122 and/or one or more first hydraulic auxiliary devices of the one or more hydraulic auxiliary devices 124 may receive the input hydraulic flow in a stream separate from the hydraulic motor 122 and/or one or more second hydraulic auxiliary devices of the one or more hydraulic auxiliary devices 124.

The one or more hydraulic linkages 123 may include one or more pipes, one or more valves, one or more hydraulic couplers, and/or one or more other hydraulic linkages. As used herein, the term “hydraulic coupler” refers to one or more devices which may, as an independent component and/or as combination of a plurality of components, enable hydraulic output equipment (e.g., the hydraulic motor 122 and/or any, some, or all of the one or more hydraulic auxiliary devices 124) that is external to a hydraulic circuit to couple (e.g., controllably and/or selectively couple) to the hydraulic circuit such that, once coupled, the hydraulic output equipment may receive hydraulic power (e.g., input hydraulic flow generated by the hydraulic pump 121).

In some examples, the hydraulic motor 122 and/or any, some, or all of the one or more hydraulic auxiliary devices 124 may be controllably, removably, and/or selectively coupled to the hydraulic circuit 120. For example, the hydraulic motor 122 and/or one or more of the one or more hydraulic auxiliary devices 124 may be controllably, removably, and/or selectively coupled to the hydraulic circuit 120 by one or more hydraulic couplers of the one or more hydraulic linkages 123. Accordingly, a user of the system 100 may, e.g., hydraulically couple their own hydraulic auxiliary device (e.g., one of the one or more hydraulic auxiliary devices 124) to the hydraulic circuit 120 to receive input hydraulic flow.

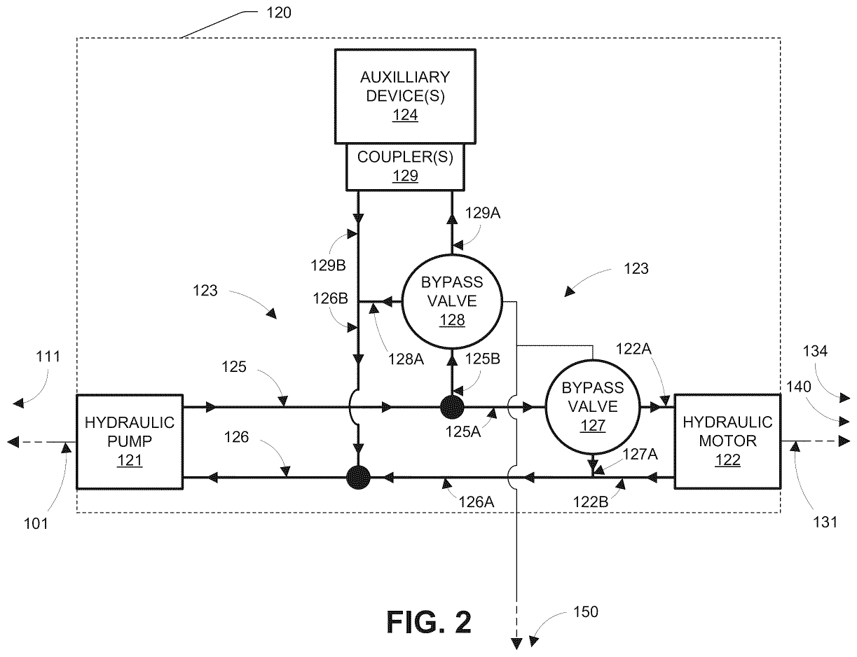

Referring now to FIG. 2, another example of the hydraulic circuit 120 is depicted. In the example of FIG. 2, the hydraulic circuit 120 is hydraulically coupled to the one or more hydraulic auxiliary devices 124 by one or more hydraulic couplers 129. In some examples, the one or more hydraulic couplers 129 enable the one or more hydraulic auxiliary devices 124 to be removably coupled to the hydraulic circuit 120, e.g., so that a user of the system 100 can hydraulically power one or more external devices (e.g., the one or more hydraulic auxiliary devices 124) owned and/or provided by the user.

The one or more hydraulic couplers 129 may include one or more pipes, one or more valves, and/or one or more other hydraulic linkages that can hydraulically couple the hydraulic circuit 120 to at least one of the one or more hydraulic auxiliary devices 124. In some examples, any, some, or all the one or more hydraulic auxiliary devices 124 are hydraulically coupled to the hydraulic circuit 120 via the one or more hydraulic couplers 129. In some examples, any, some, or all of the one or more hydraulic auxiliary devices 124 are integral components of the hydraulic circuit 120 (e.g., not requiring a hydraulic coupler to receive the input flow and/or not removably coupled to the hydraulic circuit 120).

FIG. 2 additionally illustrates an exemplary configuration of the one or more hydraulic linkages 123. In this example, the hydraulic pump 121 pumps a hydraulic fluid, as an input hydraulic flow, through a pump outlet 125 and receives the hydraulic fluid through a primary fluid return 126. The pump outlet 125 may provide input hydraulic flow to one or more sub-outlets, e.g., to hydraulically power hydraulic output equipment. For example, in the configuration of FIG. 2, the pump outlet 125 provides input hydraulic flow to a first pump sub-outlet 125A and a second pump sub-outlet 125B, e.g., such that the first pump sub-outlet 125A receives a first portion of the input hydraulic flow and the second pump sub-outlet 125B receives a second portion of the input hydraulic flow. The primary fluid return 126 may receive hydraulic fluid from one or more secondary fluid returns, e.g., after the hydraulic fluid has been received as input hydraulic flow from hydraulic output equipment. For example, in the configuration of FIG. 2, the primary fluid return 126 receives hydraulic fluid from a first secondary fluid return 126A and a second secondary fluid return 126B. In some examples, any, some, or all of the fluid returns 126, 126A, 126B may provide some or all of the hydraulic fluid to an intervening component (e.g., a fluid reservoir) in addition to, instead of, and/or prior to providing the hydraulic fluid to the hydraulic pump 121.

The first pump sub-outlet 125A provides the input hydraulic flow to a motor bypass valve 127. The motor bypass valve 127 can be configured to permit the input hydraulic flow to pass to either, both, or none of a motor inlet 122A of the hydraulic motor 122, which provides the input hydraulic flow to the hydraulic motor 122, and/or a motor bypass valve fluid return 127A, which provides the input hydraulic flow to the first secondary fluid return 126A. The motor bypass valve 127 may be actuatable between two or more states. In some examples, when in an open state, the motor bypass valve 127 may provide all of the input hydraulic flow to the motor inlet 122A, e.g., to provide all of the input hydraulic flow transferred by the first pump sub-outlet 125A to the hydraulic motor 122. In some examples, when in a closed state, the motor bypass valve 127 may provide all of the input hydraulic flow to the motor bypass valve fluid return 127A, e.g., to prevent the hydraulic motor 122 from receiving the input hydraulic flow. In some examples, when in a partially open state, the motor bypass valve 127 may provide some of the input hydraulic flow to the motor inlet 122A and some of the input hydraulic flow to the motor bypass valve fluid return 127A, e.g., to provide only some of hydraulic flow transferred by the first pump sub-outlet 125A to the hydraulic motor 122. In some examples, the motor bypass valve 127 may be configurable between any, some, or all of an open state, a closed state, and/or one or more partially open states. In some examples, the motor bypass valve 127 may be mechanically configurable (e.g., by a user of the system 100 and/or by opening when the hydraulic motor 122 is hydraulically coupled to the hydraulic circuit 120 and/or in a predetermined state), electrically configurable (e.g., by the control circuitry 150 outputting a control signal to control the motor bypass valve 127), and/or changeably configurable via one or more other mechanisms.

In the example of FIG. 2, by receiving the input hydraulic flow from the hydraulic pump 121 via the motor inlet 122A (e.g., when the motor bypass valve 127 is in an open state or a partially open state), the hydraulic motor 122 generates motor power (e.g., rotational power and/or one or more other types of mechanical power), converting some or all of the input hydraulic flow to the motor power and discharging the hydraulic fluid to a motor outlet 122B. In this example, each of the motor outlet 122B and the motor bypass valve fluid return 127A lead to the first secondary fluid return 126A, and, thereby, the primary fluid return 126, and, thereby, the hydraulic pump 121. Accordingly, in the example of FIG. 2, all or substantially all of the hydraulic fluid of the input hydraulic flow pumped by the hydraulic pump 121 through the first pump sub-outlet 125A may be returned to and received by the hydraulic pump 121.

The second pump sub-outlet 125B provides the input hydraulic flow to an auxiliary device bypass valve 128. The auxiliary device bypass valve 128 can be configured to permit the input hydraulic flow to pass to either, both, or none of one or more auxiliary device inlets 129A and/or an auxiliary device bypass valve fluid return 128A. The one or more auxiliary device inlets 129A provide the input hydraulic flow to the one or more hydraulic auxiliary devices 124, and the auxiliary device bypass valve fluid return 128A provides the input hydraulic flow to the second secondary fluid return 126B.

The auxiliary device bypass valve 128 may be actuatable between two or more states. In some examples, when in an open state, the auxiliary device bypass valve 128 may provide all of the input hydraulic flow to the one or more auxiliary device inlets 129A, e.g., to provide all of the input hydraulic flow transferred by the second pump sub-outlet 125B to the one or more hydraulic auxiliary devices 124. In some examples, when in a closed state, the auxiliary device bypass valve 128 may provide all of the input hydraulic flow to the auxiliary device bypass valve fluid return 128A, e.g., to prevent any, some, or all of the one or more hydraulic auxiliary devices 124 and/or any, some, or all of the one or more hydraulic couplers 129 from receiving the input hydraulic flow. In some examples, when in a partially open state, the auxiliary device bypass valve 128 may provide some of the input hydraulic flow to any, some, or all of the one or more auxiliary device inlets 129A and some of the input hydraulic flow to the auxiliary device bypass valve fluid return 128A. In some examples, when in a partially open state, the auxiliary device bypass valve 128 may provide only some of the input hydraulic flow transferred by the second pump sub-outlet 125B to any, some, or all of the one or more hydraulic auxiliary devices 124.

In some examples, the auxiliary device bypass valve 128 may be configurable between any, some, or all of an open state, a closed state, and/or one or more partially open states. In some examples, the auxiliary device bypass valve 128 may be mechanically configurable (e.g., by a user of the system 100, by actuating the one or more hydraulic couplers 129, and/or by opening when the one or more hydraulic auxiliary devices 124 are coupled to the one or more hydraulic couplers 129 and/or in a predetermined state), electrically configurable (e.g., by the control circuitry 150 outputting a control signal to control the auxiliary device bypass valve 128), and/or changeably configurable via one or more other mechanisms. For example, the auxiliary device bypass valve 128 may be configured to and/or controllable to not provide input hydraulic flow and/or to limit an amount of the input hydraulic flow provided to at least one of the hydraulic couplers 129 (e.g., when at least one of the one or more hydraulic couplers 129 is not coupled to at least one of the one or more hydraulic auxiliary devices 124) and/or to at least one of the hydraulic auxiliary devices 124 (e.g., when at least one of the one or more hydraulic auxiliary devices 124 are in a deactivated and/or off state).

In some examples, at least one of the one or more auxiliary device inlets 129A are coupled to at least one of the one or more hydraulic couplers 129. In some examples, at least one of the one or more auxiliary device inlets 129A are directly coupled to at least one of the one or more hydraulic auxiliary devices 124. Accordingly, in some examples, the input hydraulic flow may pass from the auxiliary device bypass valve 128 to the one or more hydraulic auxiliary devices 124 without requiring coupling via a hydraulic coupler, such as in examples wherein the system 100 does not include the one or more hydraulic couplers 129. In some examples, the one or more hydraulic couplers 129 couple at least one of the one or more auxiliary device inlets 129A to at least one of the one or more hydraulic auxiliary devices 124, e.g., to enable the input hydraulic flow to pass at least one of the one or more auxiliary device inlets 129A to at least one of the one or more hydraulic auxiliary devices 124.

In some examples, the hydraulic circuit 120 and/or the hydraulic pump 121 may include any plurality of, none of, or only one of the pump outlet 125 and/or any plurality of, none of, or only one of the primary fluid return 126. In some examples, the hydraulic circuit 120 may include no sub-outlets of the pump outlet 125 or any plurality of sub-outlets of the pump outlet 125. In some examples, the hydraulic circuit 120 may include no secondary fluid returns of the primary fluid return 126 or any plurality of secondary fluid returns of the primary fluid return 126. In some examples, the hydraulic circuit 120 and/or the hydraulic motor 122 may include any plurality of, none of, or only one of the motor inlet 122A and/or any plurality of, none of, or only one of the motor outlet 122B. In some examples, the hydraulic circuit 120, any, some, or all of the one or more hydraulic auxiliary devices 124, and/or any, some, or all of the one or more hydraulic couplers 129 may include any plurality of, none of, or only one of the auxiliary device inlet 129A and/or any plurality of, none of, or only one of the auxiliary device outlet 129B. In some examples, the hydraulic circuit 120 may include any plurality of, none of, or only one of the motor bypass valve 127 and/or any plurality of, none of, or only one of the auxiliary device bypass valve 128. In some examples, the motor bypass valve 127 may include any plurality of, none of, or only one of the motor bypass valve fluid return 127A. In some examples, the auxiliary device bypass valve 128 may include any plurality of, none of, or only one of the auxiliary device bypass valve fluid return 128A.

In the example of FIG. 2, by receiving the input hydraulic flow from the hydraulic pump 121 via the one or more auxiliary device inlets 129A (e.g., when the auxiliary device bypass valve 128 is in an open state or a partially open state), any, some, or all of the one or more hydraulic auxiliary devices 124 generate an output (e.g., compressed air, lifting power, mechanical power, electrical power, and/or one or more other types of power and/or effects), converting some or all of the input hydraulic flow to the output and discharging the hydraulic fluid to one or more auxiliary device outlets 129B. In this example, each of the one or more auxiliary device outlets 129B and the auxiliary device bypass valve fluid return 128A lead to the second secondary fluid return 126B, and, thereby, the primary fluid return 126, and, thereby, the hydraulic pump 121. Accordingly, in the example of FIG. 2, all or substantially all of the hydraulic fluid of the input hydraulic flow pumped by the hydraulic pump 121 through the second pump sub-outlet 125B may be returned to and received by the hydraulic pump 121.

In some examples, any, some, or all of the one or more hydraulic couplers 129 may receive the input hydraulic flow from a respective one or more inlets of the one or more auxiliary device inlets 129A. In some examples, any, some, or all of the one or more hydraulic auxiliary devices 124 may receive the input hydraulic flow from a respective one or more inlets of the one or more auxiliary device inlets 129A. In some examples, any, some, or all of the one or more hydraulic couplers 129 may receive the input hydraulic flow from one or more inlets of the one or more auxiliary device inlets 129A which additionally provide the input hydraulic flow to one or more others of the one or more hydraulic couplers 129 and/or at least one of the one or more hydraulic auxiliary devices 124. In some examples, any, some, or all of the one or more hydraulic auxiliary devices 124 may receive the input hydraulic flow from one or more inlets of the one or more auxiliary device inlets 129A which additionally provide the input hydraulic flow to one or more others of the one or more hydraulic auxiliary devices 124 and/or at least one the one or more hydraulic couplers 129.

In some examples, any, some, or all of the one or more hydraulic couplers 129 may outlet hydraulic fluid via a respective one or more outlets of the one or more auxiliary device outlets 129B. In some examples, any, some, or all of the one or more hydraulic auxiliary devices 124 may outlet hydraulic fluid via a respective one or more outlets of the one or more auxiliary device outlets 129B. In some examples, any, some, or all of the one or more hydraulic couplers 129 may outlet hydraulic fluid via one or more outlets of the one or more auxiliary device outlets 129B which are additionally used by one or more others of the one or more hydraulic couplers 129 and/or at least one of the one or more hydraulic auxiliary devices 124. In some examples, any, some, or all of the one or more hydraulic auxiliary devices 124 may outlet hydraulic fluid via of the one or more auxiliary device outlets 129B which are additionally used by one or more other devices of the one or more hydraulic auxiliary devices 124 and/or at least one the one or more hydraulic couplers 129.

Referring now to FIGS. 1 and 2, in some examples, the hydraulic pump 121 is directly driven by the power source 111, such as by the one or more input linkages 101 including a drive shaft directly coupling the power source 111 to the hydraulic pump 121. In some examples, the hydraulic pump 121 is indirectly driven by the power source 111, such as by being coupled by one or more linkages of the one or more input linkages 101 and/or by one or more other intervening components and/or devices. In some examples, the system 100 includes the hydraulic pump 121 as the sole hydraulic pump of the hydraulic circuit 120. In other examples, the system 100 may include a plurality of hydraulic pumps including the hydraulic pump 121 and one or more additional hydraulic pumps. In some such examples, functions of the hydraulic pump 121 described herein may be performed individually by the hydraulic pump 121 and/or collectively by a plurality of hydraulic pumps including the hydraulic pump 121. In some examples, one or more hydraulic pumps of a plurality of hydraulic pumps of the system 100 receive a respective input power from a respective power source (e.g., by the system 100 including one or more power sources in addition to the power source 111). In some examples, the power source 111 provides the input power to a plurality of hydraulic pumps including the hydraulic pump 121. In some examples, the hydraulic pump 121 is a fixed displacement pump. In some examples, the hydraulic pump 121 is a variable displacement pump. In some examples, the hydraulic pump 121 has a range of operating pressures, which can be, in some such examples, between approximately 2,500 and 4,500 pounds per square inch (“psi”). In some examples, the hydraulic pump 121 has a range of operating flow characteristics (e.g., a flow rate, flow velocity, pressure, temperature, heat output, oil weight, etc.), and, in some such examples, the hydraulic pump 121 may, thereby, vary a flow characteristic of the input hydraulic flow received by the hydraulic motor 122.

In some examples, the power source 111 is a single power source (e.g., a single engine or a single motor). In some examples, the power source 111 includes a plurality of power sources (e.g., a plurality of engines, a plurality of motors, one or more engines and one or more motors, etc.). In some examples, the system 100 includes a plurality of power sources including the power source 111. In some such examples, two or more of the power sources of the plurality of power sources may provide a combined input power to the hydraulic circuit 120 (e.g., a singular input power generated by a plurality of power sources and provided to the hydraulic circuit 120 via a single linkage of the one or more input linkages 101) and/or one or more of the power sources of the plurality of power sources may each provide an independent input power to the hydraulic circuit 120 (e.g., an input power generated by only one power source and provided to the hydraulic circuit 120 via a respective linkage of the one or more input linkages 101).

In some examples, the system 100 includes the hydraulic motor 122 as the sole hydraulic motor of the hydraulic circuit 120. In other examples, the system 100 may include a plurality of hydraulic motors including the hydraulic motor 122 and one or more additional hydraulic motors. In some such examples, functions of the hydraulic motor 122 described herein may be performed individually by the hydraulic motor 122 and/or collectively by a plurality of hydraulic motors including the hydraulic motor 122. In some examples, the system 100 includes a plurality of hydraulic circuits (one or more of the hydraulic circuits being, e.g., configured similarly to the hydraulic circuit 120, configured differently from the hydraulic circuit 120, drivingly coupled to the power source 111, drivingly coupled to one or more other power sources, etc.). In some such examples, one or more hydraulic motors of a plurality of hydraulic motors of the system 100 receive a respective input hydraulic flow from a respective hydraulic pump. In some examples, the hydraulic pump 121 provides the input hydraulic flow to a plurality of hydraulic motors including the hydraulic motor 122. In some examples, the hydraulic motor 122 is a fixed displacement hydraulic motor. In some examples, the hydraulic motor 122 is a variable displacement hydraulic motor.

In some examples, the hydraulic pump 121 provides the input hydraulic flow and/or another hydraulic flow to only one of the one or more hydraulic auxiliary devices 124 and/or to only one of the hydraulic couplers 129. In some examples, the hydraulic pump 121 provides the input hydraulic flow and/or another hydraulic flow to any plurality of the one or more hydraulic auxiliary devices 124 and/or to any plurality of the hydraulic couplers 129. In some examples, the hydraulic pump 121 provides the input hydraulic flow and/or another hydraulic flow to none of the one or more hydraulic auxiliary devices 124 and/or to none of the hydraulic couplers 129. In some examples, the system 100 includes any, some, or all of the one or more hydraulic auxiliary devices 124. In other examples, the system 100 includes none of the one or more hydraulic auxiliary devices 124.

Returning to FIG. 1, the hydraulic motor 122 may be drivingly coupled to a drive assembly 130 to provide motor power to mechanical output equipment to enable the mechanical output equipment to produce an output (e.g., DC power, AC power, welding power, compressed air, lifting power, stabilizing power, rotational power, one or more other types of mechanical and/or electrical power, etc.). As used herein, the term “mechanical output equipment” refers to one or more devices, one or more systems, and/or one or more components that receive mechanical power (e.g., rotational power) from one or more devices (e.g., one or more engines, one or more electric motors, one or more hydraulic motors, and/or one or more other types of motors), systems (e.g., a power system, a drive train, etc.), and/or components. For example, mechanical output equipment may include one or more of any, some, or all of a generator, a motor, an air compressor, a welder, an outrigger, a pump, a truck stabilizer, a crane, a lift, a grinder, and/or one or more other mechanically powered tools and/or devices.

In the example of FIG. 1, the hydraulic motor 122 provides the motor power, via the drive assembly 130, to one or more mechanical auxiliary devices 134 and a generator 140. The drive assembly 130 drivingly couples the hydraulic motor 122 to the generator 140 via one or more primary drive assembly linkages 131. The one or more primary drive assembly linkages 131 may include one or more drive shafts, one or more clutches, one or more transmissions, one or more belts, one or more gear boxes, one or more keyway couplers, one or more splines, one or more flexible couplers, one or more spider couplers, one or more flex plates, one or more flange mounts, one or more other drive shaft mounts, and/or one or more other mechanical linkages. For example, the hydraulic motor 122 may use the drive assembly 130 to provide the motor power to mechanical output equipment by rotating a drive shaft of the one or more primary drive assembly linkages 131, wherein the drive shaft is coupled (e.g., directly and/or via one or more linkages and/or drive shaft couplers), at a first end, to the hydraulic motor 122 and, at a second end, to mechanical output equipment (e.g., the generator 140 and/or at least one of the one or more hydraulic auxiliary devices 124). In the example of FIG. 1, the one or more primary drive assembly linkages 131 provide the motor power to the generator 140. In some additional and/or alternative examples, the one or more primary drive assembly linkages 131 may provide the motor power to mechanical output equipment comprising one or more systems, one or more devices, and/or one or more components (e.g., any, some, or all of the one or more hydraulic auxiliary devices 124).

By being drivingly coupled to the hydraulic motor 122, the generator 140 may receive the motor power and convert the motor power to an electrical output (e.g., AC power and/or DC power). In some examples, the generator 140 is directly driven by the hydraulic motor 122, such as by the one or more primary drive assembly linkages 131 including a drive shaft directly coupling the hydraulic motor 122 to the generator 140. In some examples, the generator 140 is indirectly driven by the hydraulic motor 122, such as by being coupled by one or more linkages of the one or more primary drive assembly linkages 131 and/or by one or more other intervening components and/or devices. In some examples, the one or more primary drive assembly linkages 131 directly couples and/or integrates the generator 140 with the hydraulic motor 122. For instance, the generator 140 and the hydraulic motor 122 may be enclosed within a single housing or otherwise physically coupled.

In some examples, the drive assembly 130 may additionally and/or alternatively provide the motor power to the one or more mechanical auxiliary devices 134. For example, one or more secondary drive assembly linkages 132 may additionally couple to the hydraulic motor 122 and/or couple to the one or more primary drive assembly linkages 131 to provide some or all of the motor power to the one or more mechanical auxiliary devices 134. The one or more secondary drive assembly linkages 132 may include one or more drive shafts, one or more clutches, one or more transmissions, one or more belts, one or more gear boxes, one or more keyway couplers, one or more splines, one or more flexible couplers, one or more spider couplers, one or more flex plates, one or more flange mounts, one or more other drive shaft mounts (to, e.g., mount to a drive shaft of the one or more primary drive assembly linkages 131), and/or one or more other mechanical linkages and/or mechanical couplers. As used herein, the term “mechanical coupler” refers to one or more devices which may, as an independent component and/or as combination of a plurality of components, enable mechanical output equipment (e.g., the generator 140 and/or any, some, or all of the one or more mechanical auxiliary devices 134) external to a drive assembly to couple (e.g., controllably and/or selectively couple) to the drive assembly such that, once coupled, the mechanical output equipment may receive mechanical power (e.g., motor power generated by the hydraulic motor 122).

In examples, the one or more mechanical auxiliary devices 134 may include one or more of any, some, or all of a generator, a motor, an air compressor, a welder, an outrigger, a pump, a truck stabilizer, a crane, a lift, a grinder, and/or one or more other mechanically powered tools and/or devices. In some examples, the hydraulic motor 122 provides the motor power to only one of the one or more mechanical auxiliary devices 134. In some examples, the hydraulic motor 122 provides the motor power to any plurality of the one or more mechanical auxiliary devices 134. In some examples, the hydraulic motor 122 provides the motor power to none of the one or more mechanical auxiliary devices 134. In some examples, the system 100 includes any, some, or all of the one or more mechanical auxiliary devices 134. In other examples, the system 100 includes none of the one or more mechanical auxiliary devices 134.

In some examples, any, some, or all of the mechanical auxiliary devices 134 may be removably coupled to the drive assembly 130 by, e.g., one or more mechanical couplers 133 of the drive assembly 130. The one or more mechanical couplers 133 may include one or more drive shaft couplers, drive shaft mounts, one or more drive shaft mounts, and/or one or more other mechanisms which enable mechanical output equipment to be removably coupled and de-coupled from the drive assembly 130 such that, when coupled, the mechanical output equipment coupled to the one or more mechanical couplers 133 may receive some or all of the motor power generated by the hydraulic motor 122. In some examples, a user of the system 100 may, using the one or more mechanical couplers 133, drivingly couple one or more external devices (e.g., a device owned and/or provided by the user) to the drive assembly 130 via the one or more mechanical couplers 133 so that the one or more external devices can receive the motor power.

In some examples, the one or more mechanical couplers 133 may mount to and/or couple to one or more of the one or more primary drive assembly linkages 131, the one or more secondary drive assembly linkages 132, the hydraulic motor 122, and/or one or more other devices and/or components of the drive assembly 130. In some examples, any, some, or all of the one or more mechanical couplers 133 are configured to always divert a set percentage and/or amount of the motor power (e.g., any, some, or all of the motor power) transferred by the one or more primary drive assembly linkages 131 and/or by the one or more secondary drive assembly linkages 132. In some examples, any, some, or all of the one or more mechanical couplers 133 are configured to selectively and/or controllably divert a set percentage and/or amount of the motor power (e.g., any, some, or all of the motor power) transferred by the one or more primary drive assembly linkages 131 and/or by the one or more secondary drive assembly linkages 132.

The generator 140 may provide the electrical output to one or more tools and/or devices. The generator 140 may additionally and/or alternatively provide the electrical output to a power conversion circuitry 141 (e.g., an individual or combined generator and/or welding power supply). The power conversion circuitry 141 may be used to condition and/or regulate the electrical output of the generator 140 for usage by one or more other devices, such as by converting the electrical output to welding power. In some examples, the conditioned and/or regulated power output can be described as a synthetic auxiliary output, with the power being converted over a range of voltage and/or current output curves and/or over a range of values (e.g., 120-240 V, 15-500 amps (“A”), at 50-60 Hz). In some examples, the system 100 is configured such that the generator 140 provides a power output for the power conversion circuitry 141 to convert the electrical output from the generator 140 to a synchronous AC power output. The power conversion circuitry 141 may include one or more AC-DC converters, one or more preregulators, and/or one or more other types of converters and/or power conversion circuitries configured to convert input power (e.g., AC power) to one or more other types of power (e.g., DC power, welding power, etc.). In some examples, the power conversion circuitry 141, which receives a variable AC input from the generator 140, is configured to generate the synchronous AC power output to one or more tools and/or devices.

In some examples, the generator 140 and/or the power conversion circuitry 141 provide the electrical output to one or more tools 142 to power the one or more tools 142. The one or more tools 142 may include any, some, or all of a welding tool (e.g., a welding torch, a wire feeder, and/or one or more other components of a welding system), a wrench, and/or another device. For example, the one or more tools 142 may include a welding torch, and the power conversion circuitry 141 may provide welding power to the welding torch to perform a welding and/or cutting operation on a workpiece 143.

The generator 140 and/or the power conversion circuitry 141 may additionally and/or alternatively provide power to one or more electrical auxiliary devices 144. For example, the generator 140 may provide the electrical output to any, some or all of the electrical auxiliary devices 144 and the power conversion circuitry 141 may additionally and/or alternatively regulate the electrical output for any, some, or all of the one or more electrical auxiliary devices 144. In examples, the one or more electrical auxiliary devices 144 may include one or more of any, some, or all of a motor, an air compressor, a welder, an auxiliary tool, an outrigger, a pump, a truck stabilizer, a crane, a lift, a grinder, a wrench, lighting, and/or one or more other electrically powered tools and/or devices. In some examples, the generator 140 and/or the power conversion circuitry 141 provide power to only one of the one or more electrical auxiliary devices 144. In some examples, the generator 140 and/or the power conversion circuitry 141 provide power to any plurality of the one or more electrical auxiliary devices 144. In some examples, the generator 140 and/or the power conversion circuitry 141 provide power to none of the one or more electrical auxiliary devices 144. In some examples, the system 100 includes any, some, or all of the one or more electrical auxiliary devices 144. In other examples, the system 100 includes none of the one or more electrical auxiliary devices 144.

In some examples, the system 100 does not include the power conversion circuitry 141. In some examples, the system 100 includes the power conversion circuitry 141 as the sole power conversion circuitry of the system 100. In other examples, the system 100 may include a plurality of power conversion circuitries including the power conversion circuitry 141 and one or more additional power conversion circuitries. In some such examples, functions of the power conversion circuitry 141 described herein may be performed individually by the power conversion circuitry 141 and/or collectively by a plurality of power conversion circuitries including the power conversion circuitry 141. In some examples, the system 100 includes a plurality of generators. In some such examples, one or more generators of a plurality of generators of the system 100 provide a respective electrical output to one or more respective power conversion circuitries of a plurality of power conversion circuitries. In some examples, the generator 140 provides the electrical output to a plurality of power conversion circuitries including the power conversion circuitry 141.

In some examples, the system 100 includes the generator 140 as the sole generator of the system 100. In other examples, the system 100 may include a plurality of generators including the generator 140 and one or more additional generators. In some such examples, functions of the generator 140 described herein may be performed individually by the generator 140 and/or collectively by a plurality of generators including the generator 140. In some examples, the system 100 includes a plurality of hydraulic motors (e.g., by including a plurality of hydraulic circuits each having one or more hydraulic motors and/or by including one or more hydraulic circuits having a plurality of hydraulic motors) and/or one or more other type(s) of motors. In some such examples, one or more generators of a plurality of generators of the system 100 receive a respective motor power from a respective hydraulic motor and/or other type of motor. In some examples, the hydraulic motor 122 provides the motor power to a plurality of generators including the generator 140.

In the example of FIG. 1, the system 100 includes the control circuitry 150. In some examples, the control circuitry 150 is and/or includes one or more control circuitries integrated into one or more components, systems, and/or devices of the system 100 (e.g., as a computing device electrically coupled to the generator 140 and integrated into a housing of the generator 140). In some additional and/or alternative examples, the control circuitry 150 is and/or includes one or more remote control circuitries (e.g., one or more cloud computing devices and/or systems, one or more cloud memory storage devices and/or systems, one or more remote controls, one or more smartphones, one or more laptops, etc.) which may, e.g., remotely transmit and/or receive signals to one or more components, systems, and/or devices of the system 100.

In some examples, the control circuitry 150 includes and/or is electrically coupled to (i.e., transmit and/or receive one or more signals to and/or from) one or more power source control units (“PSCUs”) associated with the power source 111 and/or one or more other power sources. In the example of FIG. 1, the vehicle 110 includes a PSCU 112 that controls one or more operating characteristics (e.g., an engine speed, a motor speed, a torque, an operating mode, etc.) of the power source 111.

As used herein, the terms “power source control unit” and “PSCU” refer to one or more control circuitries which may control and/or electrically communicate with some or all of the operation of one or more power sources (e.g., the power source 111 and/or one or more other power sources). In some examples, a PSCU (e.g., the PSCU 112) may be and/or include an engine control unit (“ECU”) of a vehicle (e.g., the vehicle 110) that controls (in whole or in part) an engine (e.g., the power source 111) of the vehicle. In some examples, a PSCU (e.g., the PSCU 112) may be and/or include a motor control unit (“MCU”) that controls (in whole or in part) a motor (e.g., the power source 111). In some such examples, a PSCU (e.g., the PSCU 112) may be an MCU of a vehicle (e.g., the vehicle 110) and may be integrated into, combined with, and/or otherwise working in coordination with an ECU of the vehicle. In some examples, a PSCU (e.g., the PSCU 112) may modify one or more operating characteristics (e.g., an engine speed, a torque, an operating mode, etc.) of one or more engines (e.g., an engine of the power source 111), modify one or more other operating characteristics (e.g., a motor speed, a torque, an operating mode, etc.) of one or more motors (e.g., an electric motor of the power source 111), receive a feedback signal from one or more engines (e.g., an engine of the power source 111), one or more motors (e.g., an electric motor of the power source 111), one or more other power sources, and/or one or more sensors (e.g., a power source sensor), transmit and/or receive a control signal (e.g., receive a control signal from the control circuitry 150 comprising an instruction to modify an engine speed of an engine of the power source 111 and/or to modify a motor speed of an electric motor of the power source 111), and/or perform one or more other functions relating to one or more power sources (e.g., an engine of the power source 111 and/or an electric motor of the power source 111). A PSCU (e.g., the PSCU 112) may include any, some, or all of the components, functionalities, and/or other features and/or aspects of the control circuitry 150, as described elsewhere herein.

In the example of FIG. 1, the PSCU 112 is a component of the vehicle 110. In other examples, the PSCU 112 may be, include a component of, and/or be a component of one or more control circuitries of the vehicle 110, the power source 111, a remote control circuitry (e.g., one or more cloud computing devices and/or systems, one or more cloud memory storage devices and/or systems, one or more remote controls, one or more smartphones, one or more laptops, etc.), the control circuitry 150, and/or one or more other control circuitries.

In some examples, the PSCU 112 controls the power source 111 independently. In some additional and/or alternative examples, the PSCU 112 controls the power source 111 in coordination with one or more other control circuitries, such as by controlling only one or more aspects and/or components of the power source 111. In some additional and/or alternative examples, the PSCU 112 controls the power source 111 under the partial and/or total control of one or more control circuitries (e.g., the control circuitry 150), such as by modifying an engine speed and/or a motor speed of an engine and/or an electric motor of the power source 111 based on an instruction (e.g., to increase the engine speed and/or to increase the motor speed) received in and/or determined using a control signal transmitted by the control circuitry 150. In some additional and/or alternative examples, the PSCU 112 controls the power source 111 under the partial and/or total control of one or more user interfaces, such as by modifying an engine speed and/or a motor speed of an engine and/or an electric motor of the power source 111 based on an instruction (e.g., to increase the engine speed and/or to increase the motor speed) received in and/or determined using a user interface signal transmitted by a user interface.

The control circuitry 150 may be electrically coupled to one or more devices, systems, and or components of the system 100. For example, the control circuitry 150 may electrically communicate with one or more devices, systems, and or components of the system 100, such as by transmitting and/or receiving one or more signals to and/or from one or more devices, systems, and or components of the system 100 (e.g., feedback signals, control signals, user interface signals, output equipment signals, input signals, etc.). In some examples, the control circuitry 150 may directly and/or indirectly control one or more devices, systems, and/or components of the system 100. For example, the control circuitry 150 may directly control one or more devices, systems, and/or components of the system 100 (e.g., a welding torch of the one or more tools 142, the power source 111, etc.) by transmitting a control signal that controls the one or more devices, systems, and/or components of the system 100 to modify a function, an operation, one or more operating characteristics, etc. of the one or more devices, systems, and/or components of the system 100 (e.g., controlling the welding torch of the one or more tools 142 to turn on/off, modifying an engine speed of the power source 111, modifying a motor speed of the power source 111, modifying a torque of the power source 111, etc.). As an additional and/or alternative example, the control circuitry 150 may indirectly control one or more devices, systems, and/or components of the system 100 (e.g., an air compressor of the one or more mechanical auxiliary devices 134, the power source 111, etc.) by transmitting a control signal to the one or more devices, systems, and/or components of the system 100 that includes an instruction to modify a function, an operation, one or more operating characteristics, etc. of the one or more devices, systems, and/or components of the system 100 (e.g., instructing an air compressor of the one or more mechanical auxiliary devices 134 to turn off, instructing the PSCU 112 to modify an engine speed and/or a motor speed of an engine and/or an electric motor of the power source 111, etc.).

The control circuitry 150 may be electrically coupled to any, some, or all of the one or more input linkages 101, the vehicle 110, the power source 111, the PSCU 112, the hydraulic circuit 120, the hydraulic pump 121, the hydraulic motor 122, the one or more hydraulic linkages 123, the one or more hydraulic auxiliary devices 124, the drive assembly 130, the one or more primary drive assembly linkages 131, the one or more secondary drive assembly linkages 132, the one or more mechanical couplers 133, the one or more mechanical auxiliary devices 134, the generator 140, the power conversion circuitry 141, the one or more tools 142, and/or the one or more electrical auxiliary devices 144. In some examples, the control circuitry 150 is a plurality of control circuitries. In some additional and/or alternative examples, the control circuitry 150 is and/or includes one or more remote control circuitries (e.g., one or more cloud computing devices and/or systems, one or more cloud memory storage devices and/or systems, one or more remote controls, one or more smartphones, one or more laptops, etc.). In some additional and/or alternative examples, the control circuitry 150 functions in coordination with one or more other control circuitries (e.g., one or more other control circuitries of the system 100, one or more remote control circuitries, etc.).

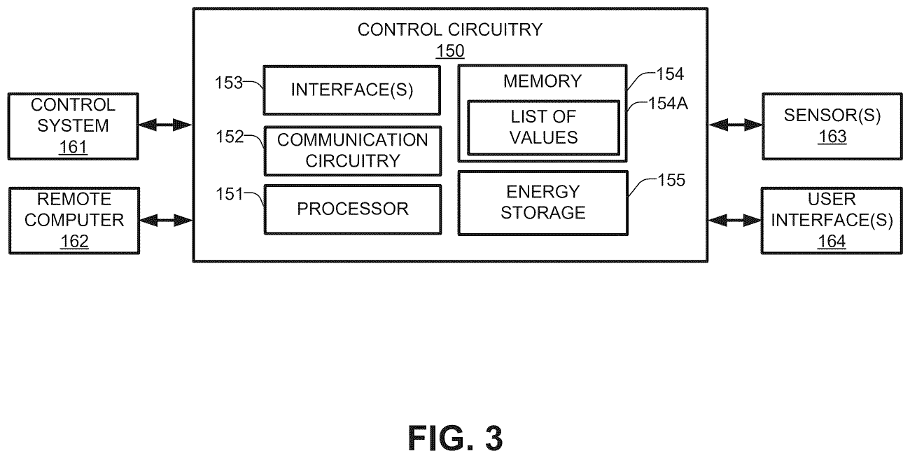

FIG. 3 is a block diagram of an example of the control circuitry 150, which can be configured as a microcontroller, or to include a processor 151, to perform as a programmable logic circuit, a system-on-chip, a programmable logic device, and/or any other type of logic circuit. The control circuitry 150 can be included in one or more components of the system 100 (e.g., the vehicle 110 and/or one or more components thereof (e.g., the PSCU 112), the hydraulic circuit 120 and/or one or more components thereof, the generator 140, the power conversion circuitry 141, the one or more tools 142, any, some, or all of the auxiliary devices 124, 134, 144, etc.), and/or be implemented as one or more remote computers 162 and/or as another control device.

In some examples, the control circuitry 150 can include communication circuitry 152 (e.g., one or more transceivers) to communicate with, e.g., the vehicle 110, one or more control systems 161 (e.g., the PSCU 112, a control system of the hydraulic circuit 120, a control system of the generator 140, a control system of the power conversion circuitry 141, one or more control systems of the one or more tools 142, one or more control systems of any, some, or all of the auxiliary devices 124, 134, 144, etc.), the one or more remote computers 162 (e.g., one or more cloud computing devices and/or systems, one or more cloud memory storage devices and/or systems, one or more remote controls, one or more smartphones, one or more laptops, etc.), a sensor system 163, a user interface 164, one or more other devices, components, and/or systems of the system 100, etc. One or more interfaces 153 can be included with or connected to the control circuitry 150, e.g., to provide a communications link with any, some, or all of the vehicle 110, the PSCU 112, the one or more control systems 161, the remote computer 162), the sensor system 163, the user interface 164, one or more other devices, components, and/or systems of the system 100, etc.

In some examples, the control circuitry 150 includes a memory storage device 154, and/or an energy storage device 155. For example, information related to operating characteristics, target operating characteristics, measured operating characteristics, etc., can be stored in a list of values 154A, e.g., as a chart, a library, etc., within the memory storage device 154.

In some examples, the system 100 can include the user interface 164 (e.g., a switch, a knob, a trigger, a display, a keyboard, a mouse, a touchscreen, a graphical user interface, a computer input device, a sensor, etc.) to provide options for an operator to control the system 100 and/or one or more components thereof.

In some examples, the user interface 164 includes a plurality of user interfaces. For example, the user interface 164 may include one or more user interfaces of hydraulic output equipment of the hydraulic circuit 120 and/or coupled to the hydraulic circuit 120 (e.g., the hydraulic motor 122 and/or any, some, or all of the one or more hydraulic auxiliary devices 124) and/or one or more user interfaces of mechanical output equipment of the drive assembly 130 and/or coupled to the drive assembly 130 (e.g., the generator 140 and/or any, some, or all of the one or more mechanical auxiliary devices 134. In some examples, the user interface 164 may generate and/or transmit a user interface signal to the control circuitry 150, which may include and/or be used to determine, e.g., target operating characteristics (e.g., a target pump characteristic, a target generated hydraulic flow characteristic, a target received hydraulic flow characteristic, a target received motor power, a target output, etc.).

Additionally or alternatively, one or more component may be in direct communication with another component, for example, one or more of the various system components (e.g., the control circuitry 150) can be directly linked to any one or more of the other components (e.g., the vehicle 110, the PSCU 112, the generator 140, the power conversion circuitry 141, one or more of the tools 142, and/or any, some, or all of the auxiliary devices 124, 134, 144) to facilitate communication.

In some disclosed examples, the control circuitry 150 monitors one or more operating characteristics of the system 100 or various devices, components, and/or systems thereof. In examples, the control circuitry 150 monitors any, some, or all of the input power, the input hydraulic flow, the motor power, the electrical output, and/or functioning of the vehicle 110, the power source 111, the hydraulic pump 121, the hydraulic motor 122, the generator 140, the power conversion circuitry 141, the one or more tools 142, any, some, or all of the auxiliary devices 124, 134, 144, and/or any, some, or all of the linkages 101, 123, 131, 132.

In some examples, the control circuitry 150 monitors one or more operating characteristics of the system 100 via a sensor system 163. The sensor system 163 may include one or more sensors, and each of the one or more sensors of the sensor system 163 may monitor one or more components and/or operating characteristics of the system 100. Each of the one or more sensors of the sensor system 163 may produce one or more feedback signals (e.g., a signal comprising and/or usable to determine one or more measured values and/or one or more measured operating characteristics), and each feedback signal may include one or more measured operating characteristics of one or more components of the system 100.

Referring again to FIG. 1, and with reference to FIG. 3, the sensor system 163 may include any, some, or all of one or more power source sensors 163A, one or more hydraulic circuit sensors 163B, one or more output equipment sensors 163C, and/or one or more other sensors.

In examples, the one or more power source sensors 163A may measure operating characteristics of the vehicle 110, operating characteristics of the power source 111, operating characteristics of one or more other power sources of the system 100, and/or an environment of the vehicle 110, and/or one or more other aspects, qualities, and/or characteristics of the power source 111 and/or one or more other power sources of the system 100. For example, the one or more power source sensors 163A may measure an engine speed of an engine of the power source 111, a motor speed of a motor (e.g., an electric motor) of the power source 111, a torque of the power source 111 (i.e., a torque generated by an engine and/or an electric motor of the power source 111), an operating mode of the power source 111 (e.g., an off mode, an on mode, a standby mode, an active mode, a synchronized speed mode, a variable speed mode, a fixed speed mode, etc.), one or more other characteristics of the input power, a temperature, pressure, or other characteristic of an environment of the vehicle 110 and/or the power source 111, etc. In some examples, any, some, or all of the one or more power source sensors 163A may be a component of the PSCU 112 and/or the control circuitry 150 (e.g., as an electrical feedback loop). In examples, the one or more power source sensors 163A may comprise one or more of any, some, or all of a thermometer, a pressure sensor, a weight sensor, a torque sensor, a tachometer, a voltmeter, a photoelectric speed sensor, a Hall effect sensor, an application specific integrated circuit (“ASIC”) sensor, a Hall ASIC sensor, a magnetic pickup sensor, and/or one or more other sensors (e.g., one or more sensors described elsewhere herein). In examples, the one or more power source sensors 163A may provide one or more feedback signals comprising one or more measured operating characteristics (e.g., a measured engine speed, a measured motor speed, a measured torque, etc.) to the control circuitry 150 and/or the PSCU 112. In some examples, any, some, or all of the power source sensors 163A may be a component of the control circuitry 150 and/or a component of the PSCU 112 (e.g., as an electrical feedback loop).

In examples, the one or more hydraulic circuit sensors 163B may measure operating characteristics of the hydraulic circuit 120, e.g. the hydraulic pump 121, the hydraulic linkages 123, any, some, or all of the inlets 122A, 129A, any, some, or all of the outlets 122B, 125, 125A, 125B, 129B, any, some, or all of the fluid returns 126, 126A, 126B, 127A, 128A, any, some, or all of the bypass valves 127, 128, and/or one or more other systems, components, and/or devices of and/or hydraulically coupled to the hydraulic circuit 120. In some examples, the one or more hydraulic circuit sensors 163B may measure one or more pump operating characteristics of the hydraulic pump 121 and/or one or more flow characteristics of the input hydraulic flow generated by the hydraulic pump 121, an input hydraulic flow within and/or through the hydraulic circuit 120 and/or the one or more hydraulic linkages 123, an input hydraulic flow received by the hydraulic pump 121 and/or the one or more hydraulic auxiliary devices 124, and/or a hydraulic fluid. The one or more hydraulic circuit sensors 163B may comprise one or more of any, some, or all of a flowmeter, a thermometer, a pressure sensor, a weight sensor, a torque sensor, a tachometer, a voltmeter, a photoelectric speed sensor, a Hall effect sensor, an ASIC sensor, a Hall ASIC sensor, a magnetic pickup sensor, and/or one or more other sensors (e.g., one or more sensors described elsewhere herein). The one or more hydraulic circuit sensors 163B may provide one or more feedback signals comprising one or more measured operating characteristics (e.g., a measured pump characteristic, a measured flow characteristic, etc.) to the control circuitry 150.

A pump operating characteristic may include a pump displacement (e.g., an amount of hydraulic fluid displaced per stroke, revolution, and/or one or more other intervals of a movement of a piston and/or one or more other components of the hydraulic pump 121, an amount of hydraulic fluid displaced by the hydraulic pump 121 during a predefined amount of time, etc.), a pump speed (e.g., a linear and/or rotational speed of a piston or other component of the hydraulic pump 121), a pump torque (e.g., a rotational force generated by one or more components of the hydraulic pump 121), a piston force (e.g., a linear force generated by a piston or other component of the hydraulic pump 121), and/or one or more characteristics of the hydraulic pump 121 and/or one or more other hydraulic pumps. A flow characteristic may include a flow rate of input hydraulic flow, flow velocity of input hydraulic flow, a pressure within a hydraulic circuit, a temperature of hydraulic fluid, a heat output of hydraulic fluid, an oil weight of hydraulic fluid, and/or one or more other characteristics of a condition, function, and/or output of the hydraulic circuit 120, the hydraulic pump 121, the hydraulic motor 122, the one or more hydraulic auxiliary devices 124, an input hydraulic flow, and/or a hydraulic fluid.

The one or more output equipment sensors 163C may measure operating characteristics and/or an environment of output equipment of the system 100, e.g., any, some, or all of the hydraulic motor 122, the one or more hydraulic auxiliary devices 124, the one or more mechanical auxiliary devices 134, the generator 140, and/or the power conversion circuitry 141. An operating characteristic may include a pump operating characteristic of a hydraulic pump, a flow characteristic of input hydraulic flow, a temperature of an environment, an air pressure of an environment, a temperature of output equipment, an operating speed, a torque, an air flow rate, an air compression characteristic of an air compressor, a lifting power of a lift (e.g., a hydraulic lift, a mechanical lift, and/or an electrical lift), a motor power generated by a motor, a load demand of output equipment, a voltage of an electrical output, an amperage of an electrical output, an operating frequency of an electrical output, an operational mode of one or more devices, and/or one or more other characteristics.

In some examples, the one or output equipment sensors 163C measure one or more operating characteristics of the hydraulic motor 122 and/or any, some, or all of the one or more hydraulic auxiliary devices 124. In some examples, the one or more output equipment sensors 163C measure a load demand of the hydraulic motor 122 and/or any some, or all of the one or more hydraulic auxiliary devices 124. In some examples, the one or more output equipment sensors 163C measure a flow characteristic (e.g., a flow rate, flow velocity, pressure, temperature, heat output, oil weight, etc.) of the input hydraulic flow and/or hydraulic fluid within, through, and/or received by the hydraulic circuit 120, the hydraulic pump 121, the hydraulic motor 122, the one or more hydraulic linkages 123, and/or any, some, or all of the one or more hydraulic auxiliary devices 124.

In some examples, the one or more output equipment sensors 163C measure an operating speed (e.g., in RPM) of the hydraulic motor 122 and/or a torque generated by the hydraulic motor 122. In some additional and/or alternative examples, the one or more output equipment sensors 163C measure an air compression characteristic of an air compressor of the one or more hydraulic auxiliary devices 124. In some additional and/or alternative examples, the one or more output equipment sensors 163C measure a lifting power generated by a hydraulic lift of the one or more hydraulic auxiliary devices 124. In some additional and/or alternative examples, the one or more output equipment sensors 163C measure a motor power generated by the hydraulic motor 122 and provided to the drive assembly 130 (e.g., output torque, operating speed, etc.).

In examples, the one or more output equipment sensors 163C measure any, some, or all of a motor power received by any, some, or all mechanical output equipment of the system 100 (e.g., any, some, or all of the one or more mechanical auxiliary devices 134, the generator 140, and/or the power conversion circuitry 141), a load demand of any, some, or all mechanical output equipment of the system 100 (e.g., a torque, operating speed, voltage, current, frequency, operating mode, etc.), an air and/or fluid pressure of any, some, or all mechanical output equipment of the system 100 (e.g., air pressure of one or more air compressors of the mechanical auxiliary devices 134), an air and/or fluid flow of any, some, or all of the mechanical output equipment of the system 100 (e.g., air flow of one or more compressors of the mechanical auxiliary devices 134), a temperature and/or pressure of an environment of any, some, or all mechanical output equipment of the system 100, and/or a desired load demand of any, some, or all mechanical output equipment of the system 100. In some examples, the one or more output equipment sensors 163C measure any, some, or all of a voltage and/or an amperage of an electrical output of the generator 140 and/or the power conversion circuitry 141, an operating frequency (e.g., in Hz) of the electrical output of the generator 140 and/or the power conversion circuitry 141, an operational mode (e.g., an off mode, an on mode, an active mode, a standby mode, a synchronized speed mode, a variable speed mode, a fixed speed mode, etc.) of the generator 140 and/or the power conversion circuitry 141, an operating speed (e.g., in RPM) of the generator 140, a temperature, pressure, or other characteristic of an environment of the generator 140 and/or the power conversion circuitry 141, and/or motor power received by the generator 140 from the drive assembly 130 (e.g., input torque, operating speed, etc.).

In examples, the one or more output equipment sensors 163C comprise one or more of any, some, or all of a flowmeter, a thermometer, a pressure sensor, a weight sensor, a torque sensor, an air pressure sensor, an air flow sensor, a tachometer, a voltmeter, a current sensor, an EMF sensor, a photoelectric speed sensor, a Hall effect sensor, an ASIC sensor, a Hall ASIC sensor, a magnetic pickup sensor, an electrical feedback loop, and/or one or more other sensors (e.g., one or more sensors described elsewhere herein). The one or more output equipment sensors 163C may provide one or more feedback signals comprising one or more measured operating characteristics (e.g., a measured flow characteristic, a measured operating speed, a measured torque, a measured load demand, a measured voltage, a measured current, a measured frequency, a measured operating state, etc.) to the control circuitry 150.

The system 100 may include one, none, and/or any plurality of any, some, or all of the sensors 163A, 163B, 163C. In examples, the system 100 may include one or more additional sensors to measure one or more additional operating characteristics of the system 100 and/or one or more components, devices, and/or systems of the system 100.

The control circuitry 150 may control the power source 111 (e.g., an engine and/or an electric motor) and/or the vehicle 110 directly (e.g., by outputting a control signal to one or more of the components) and/or indirectly (e.g., by outputting a control signal to the PSCU 112, which may, in turn, control the power source 111 according to and/or based on the control signal). For example, the control circuitry 150 may control an engine speed of an engine of the power source 111 and/or a motor speed of an electric motor of the power source 111. Accordingly, the control circuitry 150 may control the power source 111 and/or the vehicle 110 based on one or more measured operating characteristics of hydraulic output equipment and/or mechanical output equipment of and/or coupled to the system 100. For example, the control circuitry 150 may control an engine speed of an engine of the power source 111 (e.g., a rotational speed of a drive shaft of the one or more input linkages 101), an engine torque of an engine of the power source 111 (e.g., a torque of a drive shaft of the one or more input linkages 101), a motor speed of an electric motor of the power source 111 (e.g., a rotational speed of a drive shaft of the one or more input linkages 101), and/or a motor torque of an electric motor of the power source 111 (e.g., a torque of a drive shaft of the one or more input linkages 101).

The control circuitry 150 may modify an engine speed and/or a motor speed of the power source 111 according to a speed adjustment (e.g., an engine speed adjustment of an engine of the power source 111, a motor speed adjustment of a motor of the power source 111, etc.). In some examples, the control circuitry 150 and/or one or more other control circuitries may calculate a speed adjustment based on one or more measured speeds of the power source 111. For example, the one or more power source sensors 163A and/or one or more other sensors may measure a measured speed of the power source 111 (e.g., a measured engine speed, a measured motor speed, etc.) and generate a sensor signal comprising the measured speed to provide the measured speed to the control circuitry 150, the PSCU 112, and/or one or more other control circuitries. In some examples, the control circuitry 150 and/or one or more other control circuitries may calculate a speed adjustment without using a measured speed of the power source 111. A speed adjustment may include a target speed magnitude (e.g., 3200 RPM, 2400 RPM, etc.), a speed adjustment increment magnitude (e.g., +50 RPM, −20 RPM, etc.), a speed adjustment target percentage (e.g., 108% of a measured speed, 96% of a measured speed, etc.), a speed adjustment increment percentage (e.g., +2%, −6%, etc.), and/or one or more other instructions for the power source 111.

The control circuitry 150 and/or one or more other control circuitries may calculate a speed adjustment based on one or more target operating characteristics of hydraulic output equipment (e.g., the hydraulic motor 122 and/or any, some, or all of the one or more hydraulic auxiliary devices 124) and/or mechanical output equipment (e.g., the generator 140 and/or any, some, or all of the one or more mechanical auxiliary devices 134). A target output characteristic may include one or more target magnitudes of one or more metrics of input power (e.g., input hydraulic flow generated by the hydraulic pump 121, motor power generated by the hydraulic motor 122, etc.) received by output equipment (e.g., a target pump operating characteristic of the hydraulic pump 121, a target flow characteristic of an input hydraulic flow, a target rotational speed of motor power, a target torque of motor power, etc.) and/or one or more metrics of an output of output equipment (e.g., a generated psi of compressed air, a generated number of pounds per square inch of a hydraulic lift and/or of a mechanical lift, an RPM of a drive shaft, a torque of a drive shaft, a voltage, wattage, amperage, and/or frequency of an electrical current, and/or one or more other measurable aspects of a mechanical power, a hydraulic power, an electrical power, and/or one or more other types of power and/or effects).

In some examples, a target operating characteristic of hydraulic output equipment includes a target received input hydraulic flow of hydraulic output equipment (e.g., a target received flow of the hydraulic motor 122, a target received flow of any, some, or all of the one or more hydraulic auxiliary devices 124, etc.). In some examples, a target received input hydraulic flow includes a flow characteristic of input hydraulic flow generated by the hydraulic pump 121, a flow characteristic of a portion of input hydraulic flow received by the hydraulic motor 122, and/or one or more flow characteristic of one or more portions of input hydraulic flow received by any, some, or all of the one or more hydraulic auxiliary devices 124. In some examples, a target received input hydraulic flow includes a flow velocity of input hydraulic flow generated by the hydraulic pump 121, a flow velocity of a portion of input hydraulic flow received by the hydraulic motor 122, and/or one or more flow velocities of one or more portions of input hydraulic flow received by any, some, or all of the one or more hydraulic auxiliary devices 124.

In some examples, the control circuitry 150, the PSCU 112, and/or one or more other control circuitries determine a target operating characteristic based on an input signal, such as by calculating a target operating characteristic based on one or more values of the input signal and/or by an input signal including a target operating characteristic. In some examples, the control circuitry 150, the PSCU 112, and/or one or more other control circuitries may receive one or more input signals generated by any, some, or all of hydraulic output equipment (e.g., the hydraulic motor 122 and/or any, some, or all of the hydraulic auxiliary devices 124), mechanical output equipment (e.g., the generator 140 and/or any, some, or all of the mechanical auxiliary devices 134), one or more control circuitries of and/or associated with output equipment (e.g., one or more control circuitries of any, some, or all of the hydraulic motor 122, the generator 140, and/or the auxiliary devices 124, 134), one or more user interfaces of and/or associated with output equipment (e.g., one or more user interfaces of any, some, or all of the hydraulic motor 122, the generator 140, and/or the auxiliary devices 124, 134), the control system 161, the one or more remote computers 162, the sensor system 163 (e.g., any, some, or all of the sensors 163A, 163B, 163C), the user interface 164, and/or one or more other devices, systems, and/or components. In some examples, a user interface of output equipment may include one or more switches (e.g., an on/off switch), one or more knobs (e.g., a dial with several selectable magnitudes), one or more triggers, one or more displays, one or more keyboards, a computer mouse, one or more touchscreens, one or more graphical user interfaces, one or more computer input devices, one or more sensors, and/or one or more other actuatable devices (e.g., mechanically and/or electrically actuatable).

In some examples, one or more input signals may trigger an automatic response by the control circuitry 150 to control one or more components of the system 100. This response may include directly or indirectly adjusting an operating characteristic associated with one or more components of the system 100. In examples, control of the system 100 and/or one or more components thereof can be regulated by the control circuitry 150. In examples, the control circuitry 150 can adjust (directly and/or indirectly) one or more operating characteristics of any, some, or all of the vehicle 110, the power source 111, the hydraulic circuit 120, the hydraulic pump 121, the hydraulic motor 122, the one or more hydraulic auxiliary devices 124, the drive assembly 130, the one or more mechanical auxiliary devices 134, the generator 140, the power conversion circuitry 141, the one or more tools 142, and/or the one or more electrical auxiliary devices 144. Furthermore, one or more of the linkages 101, 123, 131, 132 may be controlled to completely and/or partially engage or disengage in response to the one or more operating characteristics.

The control circuitry 150 may monitor one or more input signals to determine one or more operating characteristic differences based on the one or more measured operating characteristics and one or more target operating characteristics. The target operating characteristic may be a single value (e.g., 100 RPM) or a value range (e.g., 90-110 RPM). The target operating characteristic may be a predetermined value (e.g., input via the user interface 164). Upon determining that a measured operating characteristic differs from a target operating characteristic (e.g., by differing from a target value and/or not being within a target range), the control circuitry 150 calculates a speed adjustment (e.g., an engine speed adjustment or a motor speed adjustment) based on the target operating characteristic (e.g., the operating characteristic difference) and a measured speed (e.g., a measured engine speed or a measured motor speed) of the power source 111 (e.g., as measured by the one or more power source sensors 163A). A speed adjustment is an increase (e.g., +5 RPM) or a decrease (e.g., −3 RPM) of an operating speed (e.g., an engine speed or a motor speed) of the power source 111. The speed adjustment may be a variable amount (e.g., variable depending on a magnitude of the operating characteristic difference) or an incremental amount (e.g., fixed at a predetermined magnitude per adjustment). If the operating characteristic difference is zero (e.g., no difference between the measured operating characteristic and a value of the target operating characteristic) and/or smaller than a threshold magnitude (e.g., the measured operating characteristic is within a target value range), then the control circuitry 150 may determine the speed adjustment to be zero (i.e., the speed is not adjusted). Upon calculating the speed adjustment, the control circuitry 150 outputs a control signal to control the power source 111 to modify an operating speed (e.g., an engine speed or a motor speed) of the power source 111 based on the speed adjustment to modify one or more pump operating characteristics of the hydraulic pump 121 and/or one or more flow characteristics (e.g., a flow rate, flow velocity, pressure, temperature, heat output, oil weight, etc.) of input hydraulic flow generated by the hydraulic pump 121 and received by the hydraulic motor 122 and/or any, some, or all of the one or more hydraulic auxiliary devices 124. By modifying one or more pump operating characteristics of the hydraulic pump 121 and/or one or more flow characteristics of input hydraulic flow, the control circuitry 150 can modify operating characteristics of hydraulic output equipment by modifying the magnitude of hydraulic power received by the hydraulic output equipment and/or modify operating characteristics of mechanical output equipment by modifying the motor power generated by the hydraulic motor 122.

For example, the control circuitry 150 may monitor a measured operating speed (e.g., by monitoring an input signal generated by the one or more output equipment sensors 163C) of the hydraulic motor 122 to determine an operating speed difference (e.g., −10 RPM) between the measured operating speed (e.g., 90 RPM) and a target operating speed (e.g., 100 RPM). Upon determining that the operating speed difference is not within a target operating speed range (e.g., 95-105 RPM), the control circuitry 150 may determine an engine speed adjustment (e.g., +3 RPM) of an engine of the power source 111. For example, the control circuitry 150 may calculate a modification to a flow rate of input hydraulic flow received by the hydraulic motor 122 which would adjust the operating speed of the hydraulic motor 122 to be closer to and/or within the target operating speed range, and the control circuitry 150 may calculate the engine speed adjustment based on the calculated modification of the flow rate. Upon calculating the engine speed adjustment, the control circuitry 150 may output a control signal to control the power source 111 to modify the engine speed based on the engine speed adjustment to modify the flow rate of the input hydraulic flow generated by the hydraulic pump 121 and received by the hydraulic motor 122. Accordingly, the hydraulic pump 121 receives more input power and thereby generates the input hydraulic flow at an increased flow rate, and the increased flow rate increases the operating speed of the hydraulic motor 122.

In some examples, the control circuitry 150 may control the power source 111 directly (e.g., by outputting a control signal directly to the power source 111) and/or indirectly (e.g., by outputting a control signal comprising an instruction to modify the operating speed to the PSCU 112). The control circuitry 150 may output a control signal via the communication circuitry 152, the one or more interfaces 153, and/or one or more other devices, processes, and/or mechanisms.

The control circuitry 150 may receive one or more input signals from the sensor system 163 (e.g., any, some, or all of the sensors 163A, 163B, 163C) via the communication circuitry 152, the one or more interfaces 153, and/or one or more other devices, processes, and/or mechanisms. In some examples, an input signal generated by the sensor system 163 (e.g., any, some, or all of the sensors 163A, 163B, 163C) and/or received by the control circuitry 150 may include one or more measured operating characteristics. In some examples, the control circuitry 150 may determine (e.g., via calculations, conversions, etc.) one or more measured operating characteristics based on one or more input signals generated by any, some, or all of the sensors 163A, 163B, 163C and/or one or more other sensors.

A target operating characteristic may include any, some, or all of one or more target values (e.g., 100 RPM), one or more threshold values (e.g., ≥90 RPM), and/or one or more target value ranges defined by two threshold values (e.g., 90-100 RPM). In some examples, the control circuitry 150 determines one or more target operating characteristics based on one or more user interface signals (e.g., an indication of one or more target values, one or more target threshold values, and/or one or more target value ranges) generated by the user interface 164 (e.g., via a user inputting information into the user interface 164). In some examples, the control circuitry 150 determines one or more target operating characteristics based on one or more output equipment signals generated by the one or more tools 142 and/or any, some, or all of the auxiliary devices 124, 134, 144. For example, a user interface of the one or more tools 142 (e.g., a trigger of a welding torch) and/or a user interface of any, some, or all of the auxiliary devices 124, 134, 144 (e.g., a manual switch on an air compressor of the one or more mechanical auxiliary devices 134 and/or of the one or more electrical auxiliary devices 144) may generate an output equipment signal which comprises and/or may be used to determine a target operating characteristic. As an additional and/or alternative example, a control circuitry of the one or more tools 142 and/or a control circuitry of any, some, or all of the auxiliary devices 124, 134, 144 may generate an output equipment signal which comprises and/or may be used to determine a target operating characteristic. In some examples, the control circuitry 150 determines one or more target operating characteristics based on one or more input signals generated by the sensor system 163 (e.g., any, some, or all of the sensors 163A, 163B, 163C).

In some examples, a target threshold value and/or a target value range of a target operating characteristic may be determined as a function of one or more percentages of a target value of the target operating characteristic. For example, an upper target threshold voltage value may be 105% of a target value and a lower target threshold voltage value may be 95% of a target value. In some examples, an upper target threshold value of a target operating characteristic may be based on a first percentage of a target value of the target operating characteristic, while a lower target threshold value of the target operating characteristic may be based on a second percentage, different from the first percentage, of the target value. In some examples, the control circuitry 150 determines one or more percentages used for calculating one or more target threshold values and/or one or more target value ranges of a target operating characteristic based on one or more user interface signals (e.g., one or more user-input percentages) generated by the user interface 164. In some examples, the control circuitry 150 determines one or more percentages used for calculating one or more target threshold values and/or one or more target value ranges of a target operating characteristic based on one or more magnitudes of one or more target values, one or more threshold target values, and/or one or more target value ranges (e.g., a larger magnitude being associated with a smaller percentage).

In some examples, the control circuitry 150 may monitor one measured operating characteristic or any plurality of measured operating characteristics (e.g., two measured operating characteristics, three measured operating characteristics, or even four or more measured operating characteristics), determine one operating characteristic difference or any plurality of operating characteristic differences (e.g., two operating characteristic differences, three operating characteristic differences, or even four or more operating characteristic differences), and/or modify an engine speed and/or a motor speed of an engine and/or a motor of the power source 111 based on determine one operating characteristic difference or any plurality of operating characteristic differences (e.g., two operating characteristic differences, three operating characteristic differences, or even four or more operating characteristic differences). For example, the one or more output equipment sensors 163C may measure an output generated by the one or more hydraulic auxiliary devices 124 and an operating speed of the hydraulic motor 122. In this example, the control circuitry 150 may determine either or both of a first operating characteristic difference based on the measured output and a target output and/or a second operating characteristic difference based on the measured operating speed and a target operating speed. Upon determining either or both of the first and/or second operating characteristic differences, the control circuitry 150 may output the control signal to control the power source 111 to modify an engine speed and/or a motor speed of an engine and/or an electric motor of the power source 111 based on the first operating characteristic difference, the second operating characteristic difference, or both the first and second operating characteristic differences.

In some examples, the power source 111 may be configured to operate in one or more operating modes. In examples, an operating mode of a power source (e.g., an engine, a motor, etc.) is an operational state of the power source defined by one or more predetermined parameters and/or one or more control processes. For example, a particular operating mode of the power source 111 may be a mode in which the power source 111 is being controlled to generate or is otherwise generating one or more predetermined operating characteristics and/or predetermined operating characteristic ranges. In some examples, an operating mode of the power source 111 is a function of an engine speed of an engine of the power source 111, a function of a motor speed of a motor (e.g., an electric motor) of the power source 111, and/or a function of a torque generated by the power source 111. In some examples, an operating mode of a power source may be one of a plurality of operational states in which the power source may operate. For example, the power source 111 may be configured to and/or controlled to operate in and/or transition to and/or from an on mode, an off mode, an active mode, a standby mode, a synchronized speed mode, a variable speed mode, a fixed speed mode, and/or one or more other modes. In examples, one or more operating modes of a power source may be one or more subsets of one or more other operating modes of the power source.

In some examples, an on mode of the power source 111 is an operating mode in which the power source 111 is being controlled to generate or is otherwise generating any input power and/or an input power greater than a predetermined threshold (e.g., a predetermined engine speed, a predetermined motor speed, and/or a predetermined torque) and/or within a predetermined range. In some examples, an on mode of the power source 111 may include one or more other operating modes (e.g., an active mode, a standby mode, a synchronized speed mode, a variable speed mode, a fixed speed mode, and/or one or more other modes).

In some examples, an off mode of the power source 111 is an operating mode in which the power source 111 is being controlled to not generate and/or is otherwise not generating any input power and/or an input power less or equal to than a predetermined threshold value (e.g., a predetermined engine speed, a predetermined motor speed, and/or a predetermined torque) and/or within a predetermined range.

In some examples, a standby mode of the power source 111 is an operating mode in which the power source 111 is generating an input power greater than or equal to a predetermined threshold value and/or within a predetermined range while one or more components, systems, and/or devices directly receiving some or all of the input power (e.g., the hydraulic pump 121) and/or indirectly powered partially or wholly by the input power (e.g., the hydraulic motor 122, the generator 140, and/or any, some, or all of the auxiliary devices 124, 134, 144) are experiencing no load demand and/or one or more load demands less than or equal to a predetermined threshold value and/or within a predetermined range. In examples, when in a standby mode, the power source 111 is operable to transition to one or more other operating modes (e.g., a synchronized speed mode, a variable speed mode, and/or a fixed speed mode) upon and/or during a triggering event (e.g., upon or while receiving a control signal). In some examples, after transitioning from the standby mode to another operating mode, upon another triggering event (e.g., cessation of the control signal, a predetermined time elapse, etc.), the power source 111 may be programmed and/or controlled to return to the standby mode.

In some examples, a synchronized speed mode of the power source 111 is an operating mode in which an engine speed and/or a motor speed of an engine and/or a motor (e.g., an electric motor) of the power source 111 is controlled to be synchronized with one or more target operating characteristics (e.g., one or more target values, one or more threshold values, and/or one or more target value ranges) of output equipment (e.g., the hydraulic pump 121, the hydraulic motor 122, the generator 140, and/or any, some, or all of the auxiliary devices 124, 134, 144) based on one or more measured operating characteristics of the output equipment. In some such examples, when in the synchronized speed mode, the power source 111 is controlled to maintain and/or transition an operating characteristic of the output equipment at a target value, above a threshold value, below a threshold value, and/or within a target valuer range. For example, when operating in a synchronized speed mode, an engine speed and/or a motor speed of an engine and/or a motor (e.g., an electric motor) of the power source 111 may be modified based on differences between a measured operating characteristic of output equipment (e.g., a measured operating speed of the hydraulic motor 122) and a target operating characteristic (e.g., a target operating speed of the hydraulic motor 122).

In some examples, a variable speed mode of the power source 111 is an operating mode in which an engine speed and/or a motor speed of an engine and/or a motor (e.g., an electric motor) of the power source 111 is controlled to be synchronized with one or more target load demands (e.g., one or more target values, one or more threshold values, and/or one or more target value ranges) directly exerted upon output equipment (e.g., exerted on the hydraulic motor 122 by the one or more mechanical auxiliary devices 134) and/or indirectly exerted upon output equipment (e.g., exerted on the hydraulic motor 122 by the one or more tools 142 via the generator 140 and the power conversion circuitry 141). For example, when operating in a variable speed mode, an engine speed and/or a motor speed of an engine and/or a motor (e.g., an electric motor) of the power source 111 may be modified based on differences between a measured load demand (e.g., a measured force of 14 kg being generated by a hydraulic lift of the one or more hydraulic auxiliary devices 124) and a target load demand (e.g., a target force of 16 kg to be generated by the hydraulic lift) of the hydraulic lift.

In some examples, a fixed speed mode of the power source 111 is an operating mode in which an engine speed and/or a motor speed of an engine and/or a motor (e.g., an electric motor) of the power source 111 is controlled to be synchronized with a target speed (e.g., one or more target values, one or more threshold values, and/or one or more target value ranges) of the power source 111 (e.g., a target engine speed of an engine of the power source 111, a target motor speed of an electric motor of the power source 111, a target torque of the power source 111, etc.). For example, when operating in a fixed speed mode, an engine speed and/or a motor speed of an engine and/or a motor (e.g., an electric motor) of the power source 111 may be controlled to be at a target speed or within a target speed range.

In some examples, the system 100 may include none, only one, or any plurality of the vehicle 110, the power source 111, the PSCU 112, the hydraulic circuit 120, the hydraulic pump 121, the hydraulic motor 122, the drive assembly 130, the generator 140, the power conversion circuitry 141, the control circuitry 150, and/or any, some, or all of the auxiliary devices 124, 134, 144.

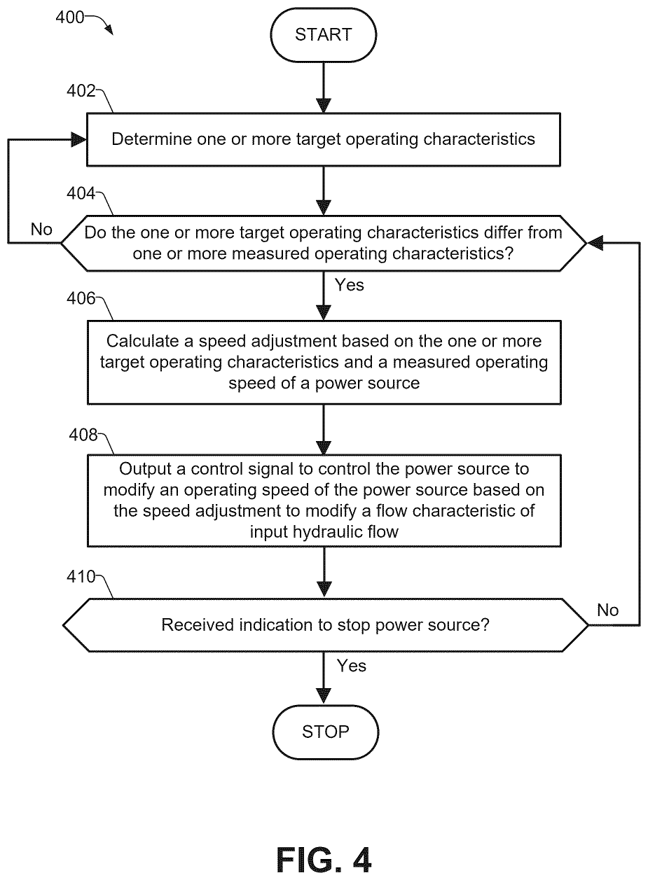

FIG. 4 is a flowchart illustrating an example of a process 400 of operating a hydraulically powered power system (e.g., the system 100). The process 400 may be implemented by control circuitry (e.g., the control circuitry 150 and/or the PSCU 112) by executing machine-readable instructions, e.g., stored on a non-transitory machine-readable storage device (e.g., the memory storage device 154). In describing the process 400, reference will be made to the examples of FIGS. 1-3. However, the process 400 may be used with other examples, such as alternative examples described elsewhere herein.

At a block 402 of the process 400, the control circuitry 150 determines one or more target operating characteristics. Each of the one or more target operating characteristics may be associated with one or more operating characteristics of any, some, or all of the hydraulic motor 122, the generator 140, the power conversion circuitry 141, the one or more tools 142, and/or any, some, or all of the auxiliary devices 124, 134, 144. In some examples, the process 400 does not include the block 402.

The control circuitry 150 may determine one or more target operating characteristics based at least in part on one or more input signals generated by any, some, or all of the user interface 164, the hydraulic motor 122, the generator 140, the power conversion circuitry 141, the one or more tools 142, any, some, or all of the auxiliary devices 124, 134, 144, the sensor system 163 (e.g., any, some, or all of the sensors 163A, 163B, 163C), and/or one or more other sensors. The control circuitry 150 may additionally and/or alternatively determine the one or more target operating characteristics based on one or more predetermined target values, one or more predetermined target threshold values, one or more predetermined target value ranges, and/or one or more percentages. The one or more target operating characteristics may include one or more target pump operating characteristics of the hydraulic pump 121, one or more target flow characteristics (e.g., generated and/or modified by the hydraulic pump 121, received and/or affecting performance of the hydraulic motor 122 and/or the one or more hydraulic auxiliary devices 124, etc.), a target temperature of an environment (e.g., of the system 100 and/or one or more components, devices, or systems thereof), a target air pressure of an environment (e.g., of the system 100 and/or one or more components, devices, or systems thereof), a target temperature of output equipment, a target operating speed of output equipment, a target torque of output equipment, a target air flow rate of output equipment, a target air compression characteristic of an air compressor, a target lifting power of a lift (e.g., a hydraulic lift, a mechanical lift, and/or an electrical lift), a target motor power generated by a motor (e.g., the hydraulic motor 122), a target load demand of output equipment, a target voltage of an electrical output (e.g., of the generator 140 and/or the power conversion circuitry 141), a target amperage of an electrical output (e.g., of the generator 140 and/or the power conversion circuitry 141), a target operating frequency of an electrical output (e.g., of the generator 140 and/or the power conversion circuitry 141), a target operational mode of one or more devices (e.g., the power source 111), and/or one or more other target characteristics of a condition, function, and/or output of output equipment. A target flow characteristic may include a target flow rate of input hydraulic flow (e.g., generated by the hydraulic pump 121 and/or received by the hydraulic motor 122 and/or the one or more hydraulic auxiliary devices 124), a target flow velocity of input hydraulic flow (e.g., generated by the hydraulic pump 121 and/or received by the hydraulic motor 122 and/or the one or more hydraulic auxiliary devices 124), a target pressure within the hydraulic circuit 120, a target temperature of hydraulic fluid within the hydraulic circuit 120, a target heat output of hydraulic fluid within the hydraulic circuit 120, a target oil weight of hydraulic fluid within the hydraulic circuit 120, and/or one or more other target characteristics of a condition, function, and/or output of the hydraulic circuit 120, the hydraulic pump 121, the hydraulic motor 122, the one or more hydraulic auxiliary devices 124, an input hydraulic flow, and/or a hydraulic fluid.

At a block 404 of the process 400, the control circuitry 150 monitors one or more input signals comprising one or more measured operating characteristics of output equipment and determines one or more operating characteristic differences based at least in part on the one or more target operating characteristics and the one or more measured operating characteristics. In some examples, the control circuitry 150 determines the one or more operating characteristic differences by determining a difference between any, some, the one or more measured operating characteristics and any, some, or all of the target operating characteristics. In some examples, in the block 404, the control circuitry 150 may not determine an operating characteristic difference by, e.g., determining that the measured operating characteristic is equal to a target value, within a target range, greater than a target lower threshold value, and/or lesser than a target upper threshold value. In some such examples, the control circuitry 150 returns to the block 402 upon determining that there is no operating characteristic difference.

The control circuitry 150 may monitor one or more measured operating characteristics by monitoring one or more input signals generated by any, some, or all of the hydraulic motor 122, the generator 140, the power conversion circuitry 141, the one or more tools 142, any, some, or all of the auxiliary devices 124, 134, 144, the sensor system 163 (e.g., any, some, or all of the sensors 163A, 163B, 163C), and/or one or more other sensors. The one or more measured operating characteristics may include one or more measured pump operating characteristics of the hydraulic pump 121, one or more measured flow characteristics (e.g., generated and/or modified by the hydraulic pump 121, received and/or affecting performance of the hydraulic motor 122 and/or the one or more hydraulic auxiliary devices 124, etc.), a measured temperature of an environment (e.g., of the system 100 and/or one or more components, devices, or systems thereof), a measured air pressure of an environment (e.g., of the system 100 and/or one or more components, devices, or systems thereof), a measured temperature of output equipment, a measured operating speed of output equipment, a measured torque of output equipment, a measured air flow rate of output equipment, a measured air compression characteristic of an air compressor, a measured lifting power of a lift (e.g., a hydraulic lift, a mechanical lift, and/or an electrical lift), a measured motor power generated by a motor (e.g., the hydraulic motor 122), a target load demand of output equipment, a measured voltage of an electrical output (e.g., of the generator 140 and/or the power conversion circuitry 141), a measured amperage of an electrical output (e.g., of the generator 140 and/or the power conversion circuitry 141), a measured operating frequency of an electrical output (e.g., of the generator 140 and/or the power conversion circuitry 141), a measured operational mode of one or more devices (e.g., the power source 111), and/or one or more other measured characteristics of a condition, function, and/or output of output equipment. A measured flow characteristic of hydraulic fluid may include a measured flow rate of input hydraulic flow (e.g., generated by the hydraulic pump 121 and/or received by the hydraulic motor 122 and/or the one or more hydraulic auxiliary devices 124), a measured flow velocity of input hydraulic flow (e.g., generated by the hydraulic pump 121 and/or received by the hydraulic motor 122 and/or the one or more hydraulic auxiliary devices 124), a measured pressure within the hydraulic circuit 120, a measured temperature of hydraulic fluid within the hydraulic circuit 120, a measured heat output of hydraulic fluid within the hydraulic circuit 120, a measured oil weight of hydraulic fluid within the hydraulic circuit 120, and/or one or more other measured characteristics of a condition, function, and/or output of the hydraulic circuit 120, the hydraulic pump 121, the hydraulic motor 122, the one or more hydraulic auxiliary devices 124, an input hydraulic flow, and/or a hydraulic fluid.

In some examples, the control circuitry 150 monitors a plurality of input signals and/or a plurality of measured operating characteristics. In some examples, the input signal comprises a plurality of measured operating characteristics. In some examples, the control circuitry 150 determines a measured operating characteristic based on the one or more input signals, e.g., by calculating the measured operating characteristic based on one or more values of the one or more input signals. In some examples, the one or more input signals are generated by any, some, or all of the hydraulic pump 121, the generator 140, the power conversion circuitry 141, the sensor system 16 (e.g., any, some, or all of the sensors 163A, 163B, 163C), any, some, or all of the auxiliary devices 124, 134, 144, and/or the one or more tools 142.

At a block 406 of the process 400, the control circuitry 150 calculates a speed adjustment of an operating speed of the power source 111 based at least in part on the one or more target operating characteristics and a measured operating speed of the power source 111. In some examples, the speed adjustment is calculated to modify a magnitude of the input power such that at least one of the one or more measured operating characteristics are brought closer to, equal to, and/or within a range of at least one of the one or more target operating characteristics. In some examples, the speed adjustment is calculated to modify a magnitude of the input power to modify one or more flow characteristics (e.g., a flow rate, flow velocity, pressure, temperature, heat output, oil weight, etc.) of input hydraulic flow generated by the hydraulic pump 121 and/or one or more other hydraulic pumps (e.g., by modifying one or more pump operating characteristics) such that a hydraulic power, a motor power, or an electrical power received by output equipment is modified to bring at least one of the one or more measured operating characteristics are brought closer to, equal to, and/or within a range of at least one of the one or more target operating characteristics.

In some examples, the control circuitry 150 calculates the speed adjustment as being a predetermined value, such as a predetermined incremental increase associated with a measured operating characteristic being less than a target operating characteristic or a predetermined incremental decrease associated with a measured operating characteristic being greater than a target operating characteristic. In some examples, the control circuitry 150 calculates the speed adjustment as a function of one or more operating characteristic differences, such as by calculating a speed increase having a magnitude proportional to a magnitude of one or more operating characteristics. In some examples, the control circuitry 150 determines a flow adjustment of input hydraulic flow generated by the hydraulic pump 121 (e.g., a change in one or more pump operating characteristics of the hydraulic pump 121 and/or a change in one or more flow characteristics of the input hydrualic flow) based on the target operating characteristic (e.g., determining a predetermined increase or decrease) and/or on the operating characteristic difference (e.g., determining an adjustment having a magnitude proportional to a magnitude of the operating characteristic difference. In some such examples, the control circuitry 150 calculates the speed adjustment based on the flow adjustment.

In some examples, the speed adjustment is an engine speed adjustment of an engine of the power source 111. In some such examples, the engine speed adjustment is calculated based on a measured engine speed of the engine of the power source 111. In some examples, the speed adjustment is a motor speed adjustment of a motor of the power source 111. In some such examples, the motor speed adjustment is calculated based on a measured motor speed of the motor of the power source 111. In some examples, the control circuitry 150 determines the measured operating speed of the power source 111 based on an input signal, e.g., generated by the one or more power source sensors 163A and/or the PSCU 112.

At a block 408 of the process 400, the control circuitry 150 outputs a control signal to control the power source 111 to modify an operating speed of the power source 111 based on the speed adjustment to modify one or more flow characteristics (e.g., a flow rate, flow velocity, pressure, temperature, heat output, oil weight, etc.) of input hydraulic flow generated by the hydraulic pump 121 and/or one or more other hydraulic pumps (e.g., by modifying one or more pump operating characteristics). In some examples, the control circuitry 150 controls the engine of the power source 111 directly. In some examples, the control circuitry 150 controls the engine of the power source 111 by outputting a control signal comprising an instruction to modify the operating speed of the power source 111 to the PSCU 112.

In some examples, the control circuitry 150 outputs the control signal to control an engine of the power source 111 to modify an engine speed of the power source 111 based on an engine speed adjustment (e.g., calculated in the block 406). In some examples, the control circuitry 150 outputs the control signal to control a motor of the power source 111 to modify a motor speed of the power source 111 based on a motor speed adjustment (e.g., calculated in the block 406).

In some examples, the process 400 ends after the block 408. In some examples, the process 400 continuously reiterates any, some, or all of the blocks 402, 404, 406, 408 until a trigger event (e.g., receiving an instruction or control signal).

At a block 410 of the process 400, the control circuitry 150 checks for receipt of an indication to stop the power source 111 and/or the process 400. In some examples, the control circuitry 150 receives an input signal from the user interface 164 (generated by, e.g., a user using the user interface 164) indicating that the power source 111 should stop operating (e.g., enter an off state) and/or that the control circuitry 150 should cease conducting the process 400. In some examples, the control circuitry 150 receives a signal from the one or more control systems 161, the one or more remote computers 162, and/or one or more other control circuitries indicating that the power source 111 should stop operating (e.g., enter an off state) and/or that the control circuitry 150 should cease conducting the process 400. In some examples, the process 400 does not include the block 410.

While the present method, apparatus, and/or system has been described with reference to certain implementations, it will be understood by those skilled in the art that various changes, modifications, and variations may be made to the present disclosure and equivalents may be substituted without departing from the scope of the present disclosure. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A hydraulically powered power system comprising:
a hydraulic pump configured to receive input power from an engine and to convert the input power to an input hydraulic flow;
hydraulic output equipment configured to receive the input hydraulic flow to generate a first output; and
control circuitry configured to:
calculate an engine speed adjustment based on a first target operating characteristic of the hydraulic output equipment and a measured engine speed of the engine, and
upon calculating the engine speed adjustment, output a control signal to control the engine to modify an engine speed of the engine based on the engine speed adjustment to modify a flow characteristic of the input hydraulic flow.

2. The hydraulically powered power system of claim 1, wherein:
the hydraulic output equipment comprises a first hydraulic auxiliary device configured to generate a first input signal comprising a first measured operating characteristic of the first hydraulic auxiliary device; and
the control circuitry is further configured to monitor the first input signal to determine a first operating characteristic difference based on the first target operating characteristic and the first measured operating characteristic, wherein the calculating of the engine speed adjustment is further based on the first operating characteristic difference.

3. The hydraulically powered power system of claim 2, wherein:
the hydraulic output equipment further comprises a second hydraulic auxiliary device configured to generate a second input signal comprising a second measured operating characteristic of the second hydraulic auxiliary device to the control circuitry; and
the control circuitry is further configured to monitor the second input signal to determine a second operating characteristic difference based on a second target operating characteristic and the second measured operating characteristic, wherein the calculating of the engine speed adjustment is further based on the second operating characteristic difference.

4. The hydraulically powered power system of claim 2, wherein:
the first target operating characteristic comprises a target received hydraulic flow characteristic of the first hydraulic auxiliary device;
the first measured operating characteristic comprises a measured received hydraulic flow characteristic of the first hydraulic auxiliary device;
the first hydraulic auxiliary device comprises a user interface configured to generate a user interface signal; and
the control circuitry is further configured to determine the target received hydraulic flow characteristic based on the user interface signal.

5. The hydraulically powered power system of claim 1, further comprising one or more hydraulic couplers configured to receive the input hydraulic flow and hydraulically couple to one or more hydraulic auxiliary devices configured to generate a second output by receiving the input hydraulic flow, wherein the calculating of the engine speed adjustment is further based on a second target operating characteristic of the one or more hydraulic auxiliary devices.

6. The hydraulically powered power system of claim 1, wherein the hydraulic output equipment comprises a hydraulic motor configured to convert the input hydraulic flow to motor power.

7. The hydraulically powered power system of claim 6, further comprising mechanical output equipment configured to receive the motor power to generate a second output, wherein the calculating of the engine speed adjustment is further based on a second target operating characteristic of the mechanical output equipment.

8. The hydraulically powered power system of claim 6, further comprising one or more mechanical couplers configured to receive the motor power and mechanically couple to a mechanical auxiliary device configured to generate a second output by receiving the motor power, wherein the calculating of the engine speed adjustment is further based on a second target operating characteristic of the mechanical auxiliary device.

9. The hydraulically powered power system of claim 1, wherein the control circuitry is further configured to, upon determining that the first target operating characteristic is a standby mode indication, control the engine to operate in a standby mode.

10. The hydraulically powered power system of claim 1, wherein the control circuitry is further configured to, upon determining that the first target operating characteristic comprises a synchronized speed mode indication, control the engine to operate in a synchronized speed mode.

11. The hydraulically powered power system of claim 1, wherein the control circuitry is further configured to, upon determining that the first target operating characteristic is a variable speed mode indication, control the engine to operate in a variable speed mode.

12. The hydraulically powered power system of claim 1, wherein the control circuitry is further configured to, upon determining that the first target operating characteristic is a fixed speed mode indication, control the engine to operate in a fixed speed mode.

13. The hydraulically powered power system of claim 1, wherein the first target operating characteristic comprises at least one of a predetermined target value or a predetermined target value range.

14. A hydraulically powered power system comprising:
a hydraulic pump configured to receive input power from an engine and to convert the input power to an input hydraulic flow;
one or more hydraulic couplers configured to receive the input hydraulic flow and hydraulically couple to one or more hydraulic auxiliary devices configured to generate a first output by receiving the input hydraulic flow; and
control circuitry configured to:
calculate an engine speed adjustment based on a first target operating characteristic of the one or more hydraulic auxiliary devices and a measured engine speed of the engine, and
upon calculating the engine speed adjustment, output a control signal to control the engine to modify an engine speed of the engine based on the engine speed adjustment to modify a flow characteristic of the input hydraulic flow.

15. The hydraulically powered power system of claim 14, further comprising a hydraulic motor configured to convert the input hydraulic flow to motor power.

16. The hydraulically powered power system of claim 15, further comprising mechanical output equipment configured to receive the motor power to generate a second output, wherein the calculating of the engine speed adjustment is further based on a second target operating characteristic of the mechanical output equipment.

17. The hydraulically powered power system of claim 15, further comprising one or more mechanical couplers configured to receive the motor power and mechanically couple to a mechanical auxiliary device configured to generate a second output by receiving the motor power, wherein the calculating of the engine speed adjustment is further based on a second target operating characteristic of the mechanical auxiliary device.

18. A hydraulically powered power system comprising:
a hydraulic pump configured to receive input power from an engine and to convert the input power to an input hydraulic flow;
a hydraulic motor configured to convert the input hydraulic flow to motor power;
mechanical output equipment configured to receive the motor power to generate an output; and
control circuitry configured to:
calculate an engine speed adjustment based on a target operating characteristic of the mechanical output equipment and a measured engine speed of the engine, and
upon calculating the engine speed adjustment, output a control signal to control the engine to modify an engine speed of the engine based on the engine speed adjustment to modify a flow characteristic of the input hydraulic flow.

19. The hydraulically powered power system of claim 18, wherein:
the mechanical output equipment comprises a mechanical auxiliary device configured to generate an input signal comprising a measured operating characteristic of the mechanical auxiliary device; and
the control circuitry is further configured to monitor the input signal to determine an operating characteristic difference based on the target operating characteristic and the measured operating characteristic, wherein the calculating of the engine speed adjustment is further based on the operating characteristic difference.

20. The hydraulically powered power system of claim 19, wherein:
the target operating characteristic comprises a target received motor power of the mechanical auxiliary device;
the measured operating characteristic comprises a measured received motor power of the mechanical auxiliary device;
the mechanical auxiliary device comprises a user interface configured to generate a user interface signal; and
the control circuitry is further configured to determine the target received motor power based on the user interface signal.
